(19) United States
(12) Patent Application Publication
(10) Pub. No.: US 2007/0276723 A1
(43) Pub. Date: Nov. 29, 2007

(54) BiPSA: an inferential methodology and a computational tool

(76) Inventor: Gideon Samid, Rockville, MD (US)

Correspondence Address: Gideon Samid, 13 Tapiola Ct., Rockville, MD, 20850, US

(21) Appl. No.: 11/790,876

(22) Filed: Apr. 27, 2007

Related U.S. Application Data
(60) Provisional application No. 60/874,957, filed on Dec. 15, 2006.
(60) Provisional application No. 60/795,641, filed on Apr. 28, 2006.
(60) Provisional application No. 60/861,037, filed on Nov. 27, 2006.

(51) Int. Cl. G07C 13/00

(52) U.S. Cl. 705/12

(57) ABSTRACT

BiPSA is a novel inferential methodology characterized by: (1) breaking down all issues of unknown and uncertainty to a cascade of binary questions, (2) identifying all available sources of knowledge, and polling each source individually with respect to each binary question in its turn. Each binary answer is associated with a measure of confidence, and is expressed in a range {N:−N}, where N is a natural number. These answers are integrated through a novel minimum-arbitrariness mathematical operation to an output of the same format, that can be treated as input to a subsequent integration thereby allowing for a construction of a network that is capable of re-configuration, responding to feedback, and hence improving the merit and the credibility of the integrated answer. Useful for various situations challenged by uncertainty and partial knowledge, e.g.: R&D, pattern-recognition, inferential image and data technology, human/machine decision-making, and management procedures.

### CROSS-REFERENCE TO RELATED APPLICATIONS

This application claims as priority date provisional applications filed by the same inventor: Application No. 60/874,957 Dec. 15, 2006 entitled Innovation Package G6d15 Application No. 60/795,641 Apr. 28, 2006 entitled Innovation Package G6428 Application No. 60/54,164 Sep. 18, 2006 entitled Innovation Package G6918 Application No. 60/861,037 Nov. 27, 2006 entitled Innovation Package G6n27

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

BiPSA stands for: “Binary Polling Scenario Analysis”. It evolved from a methodology designed to handle the dilemma of estimates inconsistencies. It has matured into a methodology designed to meet the challenge to render the unknown into known and to provide assorted computational benefits.

### BRIEF SUMMARY OF THE INVENTION

BiPSA is a tool, a procedure and a model for the process of learning, innovation, and facing the challenge of uncertainty. It is an inferential method, a means to developing credible conclusions, opinions, and estimates; extrapolating from the known into the unknown. It's principles are: (1) learning is effected through posing and answering a cascade of binary questions, (2) regarding each piece of data as an opinion source for any relevant binary question; (3) regarding every human being with relevant knowledge as an independent opinion source; (4) incorporating all available opinion sources into an integration process yielding a most credible binary answer; (5) effecting said integration through a bio-inspired network where the relative impact of the opinion sources is expressed via network configuration over nodes of unit integrators, and (6) where these unit integrators regard all their input sources as equally trustworthy, and where (7) the integrated result of these unit integrators depends only on the confidence-qualified binary opinion of these sources.

BiPSA is a component of the developing universal theory of innovation, UTI, which regards inconsistencies of data and conclusions as the starting point, and as a metric for the innovation and learning process.

BiPSA is most useful for issues of high uncertainty where a large number of sources claims relevant wisdom, but the available opinions are not necessarily mutually consistent.

BiPSA applications may be classified according to instances where the opinion sources are primarily human, vs. instances where these sources are primarily data. Thus BiPSA is applicable to challenges of R&D, management, group organization, corporate decision making—where the BiPSA respondents are human beings, as well as to pattern-recognition, image/data inference—where the sources is data, as well as to hybrid cases, like forecasting, and issue appraisals where data and humans co-contribute to the challenge at hand.

The BiPSA mathematical constructs may serve other purposes, for example: cryptographic primitives.

It appears that the BiPSA effort with respect to many serious human challengea is a beneficial one: accelerating the process of learning and innovation.

The BiPSA Model

The BiPSA model is a tool that supports and exercises the precepts of the Universal Theory of Innovation, UTI. it is designed to treat inconsistencies, and conflicts of data and conclusions in a way that reflects their significance in prompting new discoveries. BiPSA may be viewed as modified approach to inference and learning, addressing the two inherent weaknesses of the prevailing model, namely: (1) data contamination, (2) cut off practice for sources of insight. The first modification of the prevailing approach is that data is not regarded as an unquestionable truth, but rather as a source of insight or wisdom with respect to the desired conclusion.

The Universal Theory of Innovation

The notion of a universal theory of innovation may be somewhat daunting, as if the idea is the old delusional ambition to build an invention machine, a problem solving apparatus that would crank away at any innovation challenge, and prop up a solution to any problem. It's nothing of the like. The mystery of innovation should not be tampered with. The concept of UTI is to be a framework that would preserve and exploit any and all creative ideas of merit, and help them to reach maturity and an end product. Today, there is a lot of waste in the process of innovation, and the elimination of such waste and inefficiency is the object of the UTI.

The central idea of the UTI is that in order to manage and practice innovation in a rational way, it is necessary to be able to measure and track its unfolding. This is a formidable challenge.

The UTI envisions all works of innovation as efforts to realize new knowledge. To track that effort it is necessary to measure how much knowledge is being realized, acquisitioned, and how much of it is left to be realized at any given moment. This is hard to do because the unrealized knowledge is unknown. How do you quantify that which you are clueless about?

The universal theory of innovation claims that the unknown manifests itself through inconsistencies and conflicts that arise from manipulating the known. This connection between the apparent inconsistencies of experiments, and theories on one hand, and the quantity of the unknown that needs to be rendered into known is the foundation for the UTI tools including BiPSA.

BiPSA was constructed to flush out conflicts to the top of the R&D effort, and resolve these conflicts in a generic universal manner.

D-TO-A: Rendering Data (D) Into Conclusion Wisdom (C)

The process is as follows: a body of data, D, is taken to be comprised of data elements: d₁, d₂, d₃. . . dₙ

There are 2ⁿ possible subsets where some of the n data elements are grouped together. Each of those subsets would be regarded as a source of wisdom and insight with respect to the desired conclusion.

Let g₁, g₂, g₃. . . gₖ be k generic models, or theories that may lead from a given subset of D to the conclusion C. That subset dⱼ would then generate k opinions with respect to C: Cᵢⱼ=(gᵢ, dⱼ)for i=1,2 . . . k

In other words we have rendered the body of data, D, into 2ⁿk sources of opinion regarding the desired conclusion.

Below we should address the essential difference between this BiPSA proposal and the prevailing paradigm; and the philosophical justification for BiPSA. We shall follow this with an example to illustrate the D-A process.

Addressing Inconsistency

The prevailing approach calls for a source of insight to regard the whole body of data, D, resolve any apparent inconsistencies, and come forth with a cohesive, consistent proposal for the conclusions, C.

The BiPSA proposal calls for every piece of data to be an independent source of insight with respect to C. The inconsistencies are being left for the opinion integrator to handle.

The Philosophy Behind the Data to Arbitrary Insight Process

The BiPSA approach employs the notion that every fraction of D could have served as the only relevant data we know. And based on which one would have to estimate the conclusion, C. Such estimates come with a spectrum of validities, which would be sorted out later.

Given any question of concern one may envision a large number of “BiPSA dwarfs” each of which has visibility to a subset (large or small) of the available data D, and each of these dwarfs is issuing an opinion with respect to the point in question. These opinions may be in great mutual conflict. The idea is to preserve these conflicts downstream and resolve these inconsistencies after assembling them all together where they can be dealt with in a unified generic fashion.

The “Depth of the Lake” Example

Suppose one points to a lake on the map, inquiring its depth. If no data is available, and there is no pertinent model regarding the bottom of the lake, then the measure of depth is ‘anything’ goes. If there is only one data point, someone measured the lake at some unknown point, and the recorded depth was X feet then the best, and the sole estimate for the point in question would be X feet. Any other estimate higher or lower, will be without a rational basis.

If, on the other hand, there are two measured points (unknown location) with recorded values of X and Y feet, then there would be more data to conclude the depth at the point of interest, but the simplicity of using the data is lost.

One could right away devise four generic models for estimating the point in question:
1. arithmetic average: (x+y)/2
2. geometric average: √(x²y²)
3. the lower value,x
4. the higher value,y

The rational for x and y is as follows: every spot in the lake is either of depth x or of depth y. By choosing one of the two, there is a 50% chance for estimating right, by estimating an average figure there is 0% chance to estimate right.

According to BiPSA one would have here four sources of estimating wisdom (four dwarfs) with respect to the conclusion of the depth at the point of interest.

To further illustrate the BiPSA way of rendering data into sources of insight please imagine that in order to find out your best estimate of the depth of the lake at your point of interest, you turn to a group of knowledgeable individuals (sources) which live in mutual isolation. You ask each of them for his or her best estimate of the variable in question. One such source only knows that some point in the lake measured at the depth of X ft. His estimate would no doubt be X ft. Another source would only know the other measurement of Y ft, and his or her estimate would be Y ft. A third source would have in her possession the two measurements and she believes in geometric means. her estimate would be in accordance with her information and belief. And so on. One estimator would have information about 10 measurements of the lake, and even have the locations of these estimates. Another would have all that plus knowledge about lakes in that area. Yet another would possess data regarding the shapes of the bottom of lakes, and based on the location of the point of interest would produce his estimate. At the end of the day you will have a list of all your sources, each with his or her particular estimate. If they all agree, the estimating process is done. If they show some mutual disagreement, then you will face the task of sorting out ‘the truth’ using all available information regarding these sources and their trustworthiness.

In the prevailing (non-BiPSA) model someone with relevant insight would process the available data and produce a single estimate. At most two or three lake experts would be consulted, and their opinions compared, and averaged. BiPSA by contrast treats every combination of data along with a particular generic model thereof, as the sole basis for some BiPSA-dwarf to conclude his estimate from, pushing the task of resolving inconsistencies to the final (conflict resolution) step, thereby allowing for a generic, formalized way for resolving estimate inconsistencies.

Binary Breakdown of the Desired Conclusion

The idea here is that a given desired conclusion, C, can be described through a succession of more general, less specific conclusions:
C₁−>C₂−>C₃−> . . . Cₙ−>C

The first conclusions in the series are easier to deduce, the latter ones are harder to state. For example, finding anything you can identify the large area where the target is, and then narrow it down—that's concentric. You are looking for a chemical compound to fit a task. You may first characterize it as an organic compound, then add size estimate, followed by identification of functional groups, etc. That's concentric.

Any conclusion can be viewed as a selection of a conclusion option among a series of alternatives. It is claimed here that it is always possible to arrive at any conclusion through a series of cascading binary questions.

If a conclusion is an option to be selected among n alternatives, then one could build the concentric series as follows: first rank the options by their likelihood, and divide them to two groups, the high likelihood options, vs. the low likelihood ones. The question would be which group contains the desired conclusion. This is the easiest question. Second, take the winning group and again divide it into two sub groups by some measure of likelihood, and pose the question: which group contains the desired conclusion. And so on until the specific conclusion is being flushed out.

The advantage here is that if at some point the answer is in error then at least the answers up to that points are correct.

The advantage of binary questions is that any opinion source with respect to each question will be helpful as long as it has any deviation from a pure random correlation between its answers and reality. A BiPSA-dwarf which is consistently wrong is as valuable for the overall opinion about this issue as the one who is consistently right. One simply will have to flip the conclusion of the former. That flip is unique to the binary case.

The BiPSA Procedure

BiPSA works as follows: An issue of learning and research is identified, and a body of relevant data, D, is assembled, and so are various models, theories, and concepts. Lastly one recruits one or more individuals with relevant knowledge to participate in the BiPSA process.

Subsequently, the BiPSA operator should divide the issue of learning into a cascade of binary questions. And for each question one would divide D into as many subdivisions of D as practical, and combine any such subdivision with as many data models as practical to define as many as desired “BiPSA dwarfs”—virtual creatures that are assumed to know a particular subdivision of D, and believe in a particular generic inferential data model. The various theories and models of the issue are also considered BiPSA-dwarfs, and they are all grouped together with the assembled human mavens.

The dwarfs and the human mavens are all asked for their confidence-qualified opinion with respect to the binary question in point.

The various opinions are then BiPSA-integrated to produce a well balanced summary opinion on the same question.

[image]

Based on this opinion one repeats the same procedure with respect to the next binary question in the concentric series. When the final concentric question is answered, the BiPSA research and learning process is completed. The heart of the BiPSA procedure is then the integration of the various individual opinions to produce a most credible summary opinion. Albeit, the success of this procedure hinges on assembling sufficient relevant data, and identifying enough theories and models (bringing together enough dwarfs), along with identifying the knowledgeable people who are willing, or are induced to “play ball”, and give their BiPSA opinions and estimates to the issue at hand. Success also depends on the way the original issue is divided to concentric binary questions. To practice the BiPSA procedure one would have to exert a considerable effort, and so it is worthwhile only for a major R&D project, not an afternoon dilemma. All these elements would be discussed in the next section.

Philosophical Background

BiPSA is a mechanism to integrate a variety of opinions regardless of their level of consistency. It relies on the following principle:

All sources of relevant knowledge and wisdom should be consulted.

The abstract environment dealt with here is as follows: For a given issue of interest there is a true answer—absolute, and immutable. However, there is no doubt-free clear way to establish that truth. We also envision a community of referenced sources, each with some measure of relevant wisdom and knowledge. The underlying principle of choice is that that community as a whole would be the most likely to capture, approach, ‘guess’ that elusive truth, more so than any individual member or subset thereto. In other words, there is nothing to lose, and only something to gain from consulting all sources of relevant wisdom, provided one would wisely integrate these sources. This would happen if one would manage to fairly integrate the variety of opinions in that community regardless of their mutual inconsistency.

The term ‘fair integration’ is quite vague, and would not be investigated within the confines of this document. But it is nonetheless a very intuitive concept. If the community is comprised of 50 equally trustworthy individuals, and 48 of them say ‘yes’ on an issue, while two say ‘no’, then one would fairly say that the community voice would integrate into a ‘yes’.

Fair integration by no means implies “one man one vote”. To the contrary, it means each vote should be allotted a fair measure of impact on the integrated result. So it is not a pure majority count. Impact, in BiPSA is determined by three factors: (1) self confidence of the source of opinion, (2) the a-priori credentials of that source, and (3) the BiPSA record of that source for similar issues. Alas, the last factor needs time to develop. And hence, de facto BiPSA is a conservative model (preference to the majority), but with a built-in mechanism for mavericks, and exceptional human beings to rise into great community impact. This mechanism is based on a track record of performance.

BiPSA Framework Overview

We shall define:
The BiPSA environment
The BiPSA elements
The BiPSA philosophy
The BiPSA process
   The BiPSA Environment

The BiPSA environment consists of a body of knowledge T, part of which, K, is known, and the rest, U, is unknown. The environment consists of a drive, a desire and interest to render U into K—the unknown into known. K is known not by a single agent, but rather by a community of agents, say, a community of knowledge.

.The BiPSA Elements

The BiPSA elements are (1) the BiPSA environment as defined above, and (2) the BiPSA operator, (3) the BiPSA operating machinery (computer, software, data loggers), (4) the BiPSA beneficiary.

The BiPSA Methodology

Learning, finding the unknown of a topic from its known portion should be done by:
1. attacking the unknown one binary question at a time.
2. answering the binary questions on the basis of each an every subset of the known, using every reasonable inference logic.
3. integrating the answers in (2) to achieve a most credible answer to the current binary question.
4. integrating the answers to the binary questions to achieve the knowledge for the unknown, U.

In its heart BiPSA regards the knowledge realization process as one where the most elemental quantity of knowledge is taking aim at the most elemental quantity of unknown: a binary element of the unknown addressed by a single subset of the available data operated on with a single inference logic. These elements of knowledge are then integrated to the complete knowledge, U.

BiPSA challenges the common methodology which studies the known, develops a theory of the case from it, and then applies the theory to come up with the knowledge of U. The need to develop a comprehensive theory of the matter opens vulnerabilities for arbitrary assumptions, and pseudo data that serves to contaminate the assumed knowledge of U. Man likes to build theories, stories to explain his surrounding, and it easily attracts arbitrary input that steers the result away from the truth. BiPSA, by contrast, is generic to an extent because it is based in part on very little data using simple inferential logic, and a subsequent logical integration. It skips the ‘story telling’ and is hence more scientific.

It is important to make the point that simple data will easily serve for generic inferential purposes, while complicated data will require a great deal of arbitrariness to achieve the same. Re: the depth of the lake example.

The BiPSA Process

The following parts repeat in unending succession:
Preliminary work
1. identification of the environment
Case work
2. binarization of the unknown
3. dwarfing
4. challenge
5. integration of responses
6. integration of binary answers
Evolutionary enhancement
7. tracking feedback
8. incorporating feedback
   .Preliminary Work

This step is comprised of identification of the environment which consists of the matter at hand, and the implements to resolve it.

The matter at hand is comprised of the unknown, U to be known, and the relevant known, K to be used in hunting down the U. The BiPSA implements are comprised of the people, the tools, the money, and the interest to carry out the BiPSA process.

The Matter at Hand

Parts: (1) the unknown, U, and (2) the known, K. Together they define the matter at hand, T=U+K.

THE UNKNOWN, U: The measure of U cannot be clearly identified, because it is unknown. Every estimate thereto makes use of some arbitrary assumptions weather explicit or tacit. In practice one forms a question, or a scenario, and defines a relevant part of U in relation to that question or scenario. Is it true or not?

THE KNOWN, K: Any piece of available data with some—however weak—bearing on the unknown of interest, U, should be considered part of K. Based on the broad brush principle that “everything affect everything” all the data ever assembled is part of K. Practically speaking, we cannot handle ‘everything’ so we must decide on some arbitrary cut off which will be as far as possible. In fact the intrinsic advantage of BiPSA is in its ability to span a larger vista of the known compared to more common methods. At any rate, part of the process that includes this stage of defining the environment includes defining and outlining the extent of the relevant and processable K.

The BiPSA Implements

Comprised of technical tools, and administrative parts.

.TECHNICAL IMPLEMENTS: Computer systems comprised of database, communication parts, inferential software, display, recording and backup.

ADMINISTRATIVE PARTS: Comprised of:
result stakeholders
data, K, holders
the BiPSA operator
the BiPSA sponsors

All should be identified, and placed on board.

Case Work

Parts:
2. binarization of the unknown
3. dwarfing
4. challenge
5. integration of responses
6. integration of binary answers
   .Binarizaion of the Unknown

This process amounts to representing the unknown, U, as a series of binary questions configured as a binary tree of the form:

Ask Qi If the answer to Qi is yes, ask question QY(i+1). If the answer to Qi is no, ask question QN(i+1).

Repeated for i=1,2,3 . . . u such that when all u questions are answered the body of unknown, U is rendered fully known. The binary questions may refer to detailed scenarios. So, if one tries to learn the detailed of some biochemical process in the human body, she can describe the process in general term, if the answer is ‘yes’ then it will describe a more detailed scenario. If the answer is ‘no’ then another detailed scenario would be asked, and again, until one is responded-to with a BiPSA-yes, and then it is further particularized.

The binarization process is carried out by the BiPSA operator in conjunction with the data holders.

Dwarfing

Dwarfing is a central process in BiPSA. The central idea is that the best use of a body of relevant knowledge K (to learn an unknown U) is by breaking it down to all possible knowledge subsets, challenging each subset with the binary questions that are the result of the binarization process, and subsequently integrating these answers in a ‘fair and balanced’ way. This is in opposition to the common approach of constructing a theory from K, and using that theory to establish the knowledge of U.

A dwarf is a combination of a given body of data and a given inference logic. Such a combination can be used to answer the current binary challenge. The greater the amount of data, the more logical inferential formulas appear reasonable and rational. If the body of data K is a combination of n data elements, then K will define 2ⁿ knowledge subsets. Each of which would have to be multiplied by an average of 1 inferential formulas, resulting in I*2ⁿ dwarfs. This might be a daunting number, so that in practice one would select a portion thereto, and the definition of the dwarfs and their selection is the process of dwarfing the body of knowledge, K.

Note: each dwarf, based on its content should also be associated with a relevance index, indicating how relevant is it to the question in point. This relevance index would be used to construct the integration network. One could include the determination of relevant index for each dwarf as formally part of the dwarfing process.

One question of interest is the nature of the inferential logic, addressed below.

INFERENTIAL LOGIC: The history of mathematics has identified a number of inferential logics to deduce an unknown on the basis of a known.

Broad categories:
1. sameness
2. extrapolation
3. subsetting

Sameness says: what there is, is what will be; what prevails in the known, prevails in the unknown. Extrapolation looks for trends and extends them into the unknown. Subsetting is a process of viewing the data as a subset of a larger picture, which is investigated through that data. The targeted unknown is seen as another subset of the studied larger picture, and from its deduction it is subsequently inferred.

.SAMENESS: The rational here is to assume that something is fixed and the same throughout the realm at hand: the same in the known, and the same in the unknown. To the extent that measurements and data show variance, this is because of errors, misconceptions, and other distractions, so the one should try to counter them, deduce the ‘true’ fixed value, and project it to the unknown.

Example: If two inspected spots showed the depth of a lake to be X and Y (x [symbol] Y), then one would hunt for the true value Z which represents the fixed depth of the lake. Z can be deduced through various logic patterns:
1. arithmetic mean
2. geometric mean
3. choosing one or the other

In sameness, the location of the inspected spots makes little difference, because one assumes a fixed same depth for the lake.

EXTRAPOLATION: The logic here is that underlying the data one finds a stable trend, that if picked up from the data, can be used to extrapolate into the unknown.

Extrapolation may be linear, or non-linear. It may be deterministic a-la Lagrange, or it may be stochastic, using a regression formula or alike.

SUBSETTING: In this mode, one builds a larger story of reality, characterizes it through the relevant data, and then deduces the unknown as part of the big story—the underlying theory. This mode is the foundation of the glory of science. The amazing successes of Newton's gravitation, Einstein mechanics, Quantum Mechanics make this method the most elegant, the most coveted among the three.

.Challenge

In this process the binary questions listed in the binarization process become challenges for each dwarf identified in the dwarfing process. The challenge is to come up with a binary answer.

The process takes a different form depending on the nature of the dwarf: be it a person, or be it a data element combined with an inferential logic.

CHALLENGING HUMAN ‘DWARFS’: In one respect challenging human sources (‘dwarfs’) is so much easier than challenging unanimated data. People may be instructed to come up with a binary answer, leaving the question of how to come up with that answer to the source herself. On the other hand, it is more difficult since people have to be reached, communicated to, and from; they must be motivated, compensated, treated with respect, etc.

Challenging human sources requires a proper administration to handle and manage the respondents, and it requires the proper technology to provide secure communication of the question, the relevant data, and the answer.

Dealing with human beings, as challenging as it may be, may harvest unscheduled benefit. The simple fact that a bunch of intelligent people think of the matter at hand (in order to provide a binary answer) leads to having some of those people incur some important, even dramatic, new insight to help the cause.

.DATA DWARFS: Data dwarfs don't require management, nor elaborate communication, they don't need motivation, they don't get insulted, etc. However one needs to translate the original data answer to the BiPSA range {−N:+N}. This step introduces some limited arbitrariness that is not too harmful because it is neutral as far as the binary response may be. The data dwarf must answer yes/no on the binary question, and must also supply a statement of confidence for its answer. This is done in ways that are typical to the case.

Example: The binary question will regard the statement that a cost figure of a given project would be less than $X. The data dwarf might estimate the cost to be $Y. Now, arbitrary setting will translate that answer to BiPSA terms. If essentially X≈Y the BiPSA answer would be zero. If Y>X the answer will be negative, and the higher the gap (Y−X) the closer the answer to “−N”. Conversely for Y<X. The answer would be positive, and the greater the gap (X−Y) the closer the BiPSA answer would be to “+N”.

.Integration of Responses

The various BiPSA respondents (“dwarfs”) need to undergo integration that would produce a ‘fair and balanced’ summary in the same format: {−N:+N}. BiPSA performs this integration in a unique and characteristic way. The various impacts and counter- impacts are expressed via the BiPSA network configuration. Impact of individual votes is developed based on (1) self confidence in the answer, (2) the past credential of the source, and (3) the BiPSA record of the source. The latter develops over time, and affects the BiPSA network configuration.

This integration step is central to the BiPSA idea. That is why the matter at hand undergoes binarization, and that is why the source of knowledge is ‘dwarfed’ into elemental units. The full burden of settling inconsistencies is carried out in this step. It is all brought up and focused here. It would be easier to settle some inconsistencies at lower stages, with fewer items to rectify, but it is more exhaustive and more comprehensive to do it this way: considering all the various opinions (answers) simultaneously.

.Integration of Binary Answers

The sequential BiPSA answers to the binary questions accumulate and develop to a complete answer to the original challenge: learning the original unknown. In fact, every binary answer determines what will be the next binary question until the target unknown is fully known.

Evolutionary Enhancement

Elements:
tracking feedback
incorporating feedback

The first item amounts to tracking down events of reality that would serve as a check on the estimates and opinions of the BiPSA process. The second item amounts to adjusting the BiPSA network (the response integration) to reflect the knowledge gained from these reality checks. Typically, reality vindicates some BiPSA respondents, and implicates others as wrong. The former would gain a greater impact in the revised configuration for similar cases, and the latter, the opposite—their impact would be diminished. In short, every round of feedback from the evolving reality would result in changes within the BiPSA network configuration.

Terms and Definitions

BiPSA: A methodology and a mathematical tool designed primarily to serve the learning and inferential processes, but has also developed into other uses. Originally an acronym: Binary Polling Scenario Analysis, but evolved into a proper name.

The BiPSA question: A binary question posed for the BiPSA respondents to answer BiPSA respondent: Alias: BiPSA source, BiPSA voter, BiPSer: Any entity that responds to the BiPSA binary question, and is then integrated to the summary response.

The BiPSA standard response; alias: the standard BiPSA answer: a BiPSA vote: A yes/no answer to the BiPSA binary question, qualified with degree of self conviction in that answer. The standard BiPSA response is expressed in the range {−N:+N} where N is a natural number. The higher the absolute value of the answer the greater the conviction of the BiPSA respondent in his response. The BiPSA response will include “+0” and “−0”. The former represents indecision between the two binary options, the latter represents non-participation, the respective respondent did not engage in responding to the question at hand.

BiPSA Integration: The process of representing a series of BiPSA responses as a single same format response in a ‘fair and balanced’ way.

BiPSA binarization: The process of dividing any issue of learning, unknown, or uncertainty into a series of binary questions. Needed because BiPSA calls for learning any issue of interest one binary question at a time.

BiPSA: Mathematical Definition

BiPSA is a network comprised of threaded unit integrators. It maps n input variables, to m output variables, where all variables have a BiPSA-range: integers in the interval [N:−N], where N is any natural number.

We shall define:
The BiPSA Unit Integrator
The Reverse BiPSA Unit Integrator
The BiPSA Network
   The BiPSA Unit Integrator

[image]

A BiPSA Unit integrator is a mathematical function, or operator that maps n input variables: b₁, b₂, b₃, . . . bₙ into a single output variable b₀ where all (n+1) variables have a BiPSA range.

Notation:

b₀=[b₁,b₂, . . . bₙ]=[b₁,b₂, . . . bₙ]_{BiPSA}=[{b}ₙ]

The BiPSA unit integrator may be regarded as the BiPSA unit operator, or simply the operator, and also the BiPSA unit function, or the BiPSA function.

From the various possible BiPSA functions we shall distinguish a subset called nominal BiPSA functions, or operators. This subset would be defined as functions that satisfy the nominal conditions, as defined below.

The Nominal BiPSA Terms

The nominal BiPSA terms applied to any BiPSA function are as follows:
1. single output term.
2. Permutation invariance.
3. Symmetry
4. Monotony
5. Full-range terms for same sign instances.
6. Full-range terms for mixed signs instances.
7. N-invariance

The single output terms indicates that every set of input variables would be mapped into one and only one BiPSA output.

Permutation Invariance

This condition (term) specifies that the BiPSA result would not change when the values of the n input variables are assigned to different variables. In other words the BiPSA output is the same under any permutation of the inputs. This means that all input variables are treated equally. Or yet, in other words, a set of n values leads to the same BiPSA output value regardless of how these values are assigned to the n input variables.

.Symmetry

If all the signs of the n input variables are switched, then the sign of the BiPSA output switches too, but the absolute value remains the same.

Say:

Let b*ᵢ=−bᵢ for i=1,2,3, . . . n

then:

[bᵢ, b₂, b₃, . . . bₙ]=−[b*n₁, b*n₂, b*n₃, . . . b*nₙ]

.Monotony

The monotony conditions says that if the value of an input variable increases, then the BiPSA output value must not decrease. It can increase or stay the same. And conversely, if the value of an input variable decreases, then the BiPSA output value must not increase.

Say,

If b*ᵢ>bᵢ for all values i, then:

[b*₁, b*₂, . . . b*ᵢ, . . . b*ₙ]>=[b₁, b₂ . . . bᵢ, . . . bₙ]

and conversely:

If b*ᵢ<bᵢ for all values i, then:

[b*₁, b*₂, . . . b*ᵢ, . . . b*ₙ]=<[b₁, b₂ . . . bᵢ, . . . bₙ]

.Full-Range Terms for Same Sign Instances

For any values of n, and N there exists such a value of same sign n input variables so that each of the values within the range [−N:+N] will be the BiPSA output. In other words a nominal BiPSA function would not skip on any of the possible 2N+1 values for its output.

We may also mention the extended full range term for same sign instances, as the term that indicates that there should be n different sets of inputs that produce each and every possible output value.

.Full-Range Terms for Mixed Signs Instances

For any values of n, and N there exists such a value of mixed signs n input variables so that each of the values within the range [−(N−1):+(N−1)] will be the BiPSA output. In other words, a nominal BiPSA function would not skip on any of the possible 2N−1 values for its output.

We may also mention the extended full range term for mixed signs instances, as the term that indicates that there should be n different sets of inputs that produce each and every possible output value.[−(N−1):+(N−1)]]

.N Invariance

Let M be the highest absolute value within a set of BiPSA inputs. The N-invariance condition states that the BiPSA output value would be the same for any value of N≧M.

.Zero Notations for BiPSA Variables

We shall distinguish between a “+0” (a plus zero), and a “−0” (a minus zero) as BiPSA variables. The former is a valid entry in the range {−N:+N}. In the uncertainty implementation, a plus-zero is a vote of ‘can't decide’ over the binary question. The voter declaring that as a result of contemplating the question in point, the two options look at equal likelihood, or nearly so. Minus-zero means, no entry. A minus zero is equivalent to no vote, no entry.

The Reverse BiPSA Unit Integrator

The reverse BiPSA unit integrator is an integrator that integrates the inputs with opposite signs.

BiPSA Network

The BiPSA network is a configuration in which n BiPSA input variables are processed by a ‘first generation’ of I₁ BiPSA unit integrators, and thereby define n+I₁ BiPSA variables, which may be fed into I₂ unit integrators (second generation), to produce n+I₁+I₂ BiPSA variables, and so on, for generation k there are n+I₁+I₂+ . . . I₍ₖ₋₁₎ input variables that may be regarded as input variables for the k-th generation of Iₖ BiPSA unit integrators, producing Iₖ output variables.

If all the utilized BiPSA unit integrators are nominal, then the network is regarded as nominal.

BiPSA: Nominal Operators

As defined a nominal BiPSA operator is an operator that satisfies the six terms of nominal status. These terms significantly narrow down the range of acceptable operators. The nominal BiPSA terms lead to some BiPSA theorems that express the nominal restriction. we shall list some of those, then we shall focus on one particular nominal BiPSA algorithm, the opinion integrator of the first order (OI−1st), which was developed for the original purpose of BiPSA: integrating binary opinions. We shall subsequently focus on the respective BiPSA network.

Nominal BiPSA Theorems

The following are theorems that derive from the definition of the nominal BiPSA operator.

T−1.0=[0,0, . . . 0]

Or say, if for all i=1,2,3 . . . n bᵢ=0 then b₀=0.

This is due to the symmetry term. If (x≠0)=[0,0, . . . 0] then upon reversal of signs the output should be −x, while the input variables do not change, which is an impossibility according to the single output term.

T−2: For every N and n, if bᵢ=M for all i=1,2,3 . . . n, then b₀=M

Or say:

M=[M,M,M . . . . M]

Proof if there was (X≠M)=[M,M, . . . M], then if N=M, we would have |X|<M. (Since the output range would be M:−M). And the output of M would have to be generated by another input set: M=[b₁, b₂, b₃, . . . bₙ]. But since M=N the {b}n set would have to have at least one variable less than M, and hence the corresponding output, X, would have to be X≧M according to the monotony term, which contradicts our initial conclusion, and hence necessarily X=M, which proves lemma A−3 for N=M. The N-invariance terms would prove the same for every N>M.

T−3: M−1=[M,−1]

Proof For N=M, the pair (M,−1) is the highest mixed signs combinations, and thus to satisfy the monotony condition it should evaluate to yield the highest BiPSA output value in the range 0, . . . (M−1). And because of the N-invariance condition, the same is true for any value of N≧M.

T−4: {M−1,M}=[M,L] for M>L≧0

Theorem T−4 says that the range of BiPSA values for two same sign inputs is within these inputs.

Proof: X=[M,L] cannot be smaller than M−1 because of T−3, and the monotony term, it cannot be larger than M because of the N-invariance term, and hence the only allowable values for X are M−1, and M.

These theorems reduce the range of possible BiPSA algorithms.

In particular, for any two integers, M and L where M>L>0 we have:

M=[M,M, . . . M.] and L=[L,L,L . . . L]

for any given value of n counts of input variables. Hence the range: [L,M,M, . . . M] [L,L,M, . . . M] [L,L,L, . . . M] [. . . M] [L,L,L, . . . ,L,M]will have to be covered by a BiPSA output between L and M. And in particular, for L=M−1, the n BiPSA values will have to span the range between M−1 and M, only two values to which n BiPSA sets must reduce to.

The Opinion Integrator of the 1st Order

We shall first define this particular nominal BiPSA algorithm, discuss some of its attributes, then offer a brief discussion regarding its origin.

Opinion Integrator: Definition

The OI-1st is a nominal BiPSA unit integrator where:

For L and M natural numbers, or zero, and M>L we satisfy:

OI1-1. (M−L)=[M,−L]

OI1-2. M−1=[M, L] for L=0,1,2, . . . (M−2) and M=[M, L] for L=M−1

These two conditions fully define this OI BiPSA algorithm for n=2. BiPSA is naturally defined for n=1 x=[x].

For n>2 we need more definitions, as follows:
OI1-3: evaluating same sign BiPSA input set for n>2
OI1-4: evaluating mixed signs BiPSA input set for n>2
   .OI Same Sign for N>2

Proceed as follows:

I. list the input entries by order: b₁, b₂, b₃, . . . bₙ such that for i=1,2, . . . (n−1) there will be: bᵢ=<bᵢ₊₁

II. eliminate the members of this list by pairs, taking one element from each edge, until the list contains either one or two elements. Evaluate the BiPSA output value for the remaining list—this is the BiPSA output value for the original list.

Say: after eliminating the first pair, the (n−2) members list looks like this: b₂, b₃, . . . bₙ₋₁ and after the next step (if n is large enough), the list contains (n−4) members and looks like this: b₃, . . . bₙ₋₂

III. A zero value may be treated as either positive or negative sign.

### EXAMPLES

Evaluate: X=[4,2,1,3,1,2,3,2,1]

Rank ordering the list: 1,1,1,2,2,2,3,3,4

Eliminating the first pair: 1,1,2,2,2,3,3 then the 2nd: 1,2,2,2,3 and the third: 2,2,2 and finally the fourth: 2, which evaluates to 2, hence: x=2

Evaluate: X=[4,2,1,3,1,3,2,1]

Rank ordering the list: 1,1,1,2,2,3,3,4

Eliminating the first pair: 1,1,2,2,3,3 then the 2nd: 1,2,2,3 and the third: 2,2 which evaluates to 2, hence x=2

OI Mixed Signs for N>2

Proceed as follows:

I. separate the positive entries into a “plus list” and aggregate the negative entries into a “minus list;” ignore any zero valued entries.

II. Equalize the size of the two lists by adding inputs valued as zero to the smaller list.

III. Evaluate the two lists according to the same sign procedure described above, and compute two values: the BiPSA integrated value of the plus-list, and the BiPSA-integrated value of the minus-list.

IV. Evaluate the two BiPSA values generated in (3) according to the definition of the OI-1st algorithm for n=2, the result is the BiPSA integrated value of the original mixed list.

### EXAMPLES

1. Evaluate: X=[5,−2,+3,−1, 0,−1,+4,−2,−1, 0]

Building the plus-list: [5,3,4] Building the minus-list: [−2,−1,−1,−2,−1]

Padding the smaller plus list to: [5,3,4,0,0] The plus list evaluates according to the same sign rules as:

3=[5,3,4,0,0]

And he minus-list evaluates to: −1=[−2,−1,−1,−2,−1]

Accordingly: x=[3,−1]=2

Opinion Integrator: Attributes

The OI-1st BiPSA UI satisfies the nominal terms, and in particular is clearly monotonous.

The BiPSA Network

Since the BiPSA output is of the format of the BiPSA inputs, it's possible to thread a network of BiPSA unit integrators.

We shall define:
The Weighted BiPSA
The BiPSA network matrix

The former is a standard small BiPSA network, and the latter is the standard expression for the BiPSA network.

The Weighted BiPSA

The BiPSA unit integrator operates with permutation invariance, which keeps all inputs on equal footing. If one wishes to account for the various weight or impact of particular inputs (voters) then one would construct a proper network called the weighted BiPSA, defined herewith:

Given a BiPSA modular normal set: b₁, b₂, b₃, . . . bₙ one would pair each element bᵢ therein with an integer, wᵢ creating:

(bᵢ, wᵢ) for i=1,2, . . . n

These pairs would be used as an input for a newly defined function: the weighted BiPSA: bw₀=[(b₁, wᵢ), . . . (bₙ, wₙ)]_{weight}

defined as follows:

let:

w=(|W|₁, |w₂|, |w₃|, . . . |wₙ|)max

Do:

1. construct a BiPSA set comprised of all bᵢ values where wᵢ≠0. If wᵢ<0, then the corresponding element in that BiPSA set would be:

(−1)*bᵢ

otherwise, the original bᵢ would be used.

Let b₀₁ be the result of so defined BiPSA set.

2. construct a BiPSA set comprised of all bᵢ values where |wᵢ|>1. If wᵢ<0, then the corresponding element in that BiPSA set would be:

(−1)*bᵢ

otherwise, the original bᵢ would be used.

Let b₀₂ be the result of so defined BiPSA set.

Similarly define: b₀₃, b₀₄, . . . b_{0w}:

For b₀ⱼ construct a BiPSA set comprised of all bᵢ values where |wᵢ|>j−1. If wᵢ<0, then the corresponding element in that BiPSA set would be:

(−1)*bᵢ

otherwise, the original bᵢ would be used.

Let b₀ⱼ be the result of so defined BiPSA set.

Next, assemble the w BiPSA values:

b₀₁, b₀₂, . . . b_{0w}

into a BiPSA set. Its result,

bw₀=[b₀₁, b₀₂, . . . b_{0w]}

would be the output of the weighted BiPSA procedure:

bw₀=[(b₁, w₁), . . . bₙ, wₙ)]_{weight}

We shall also use an alternative notation as follows:

bw₀=[b₁, . . . bₙ;w₁ . . . wₙ]

The above procedure insures that the i-th BiPSA unit integrator would be integrating the sources that have a weight attribute i or above, where i=1,2, . . . W. The (W+1)-th unit integrator would integrate the W outputs of these W unit integrators.

This set-up would count sources of weight j, j times, where j=1,2, . . . W, and sources of weight zero, zero times.

Any BiPSA variable with a weight of zero, would not be integrated at all. If all the weights are zero, then the operation is not defined.

The weighted BiPSA would also be written in the following form:

[b₁, b₂, b₃, . . . bₙ; w₁, w₂, w₃, . . . wₙ]

Alternatively we shall define a BiPSA value vector, b, and a BiPSA weight vector w as:

b=b₁, b₂, b₃, . . . bₙ

w=w₁, w₂, w₃, . . . wₙ

and the weighted BiPSA would be expressed as [b,w].

The Extended BiPSA Weight Integrator

We may wish to allow a certain input source to be counted in reverse. Its value would be counted with the opposite sign with a given weight. Such counting would be indicated by a minus ordinal: −1,−2, . . . −w.

This extension would shape the weight values in the format of the BiPSA values: {−N:+N}. Note that the N limit on the weight is not necessarily the N limit for the BiPSA variable, although the lower value can be increased to equality without adverse effects. The extended BiPSA weight integrator may be called the BiPSA weight integrator, if there is no need to distinguish it.

.Attributes of the Weight Integrator

The following lemas follow directly from the definition of the BiPSA weight:

1. for w=a,a, . . . a, [b,w]=[b] for a=1,2, . . .

2. for w=0,0, . . . wᵢ, . . . 0,0, where wᵢ>0 [b,w]=bᵢ

The BiPSA Network Matrix

Consider a vector of n BiPSA values: b=b₁, b₂, b₃, . . . bₙ and k weight vectors of n elements each: wⱼ=w₁ⱼ, w₂ⱼ, . . . wₙⱼ

These k vectors would define a matrix W of k columns and n rows, where the element in row i and column j is the weight indicator associated with bᵢ according to weight vector j.

$$W = [ \begin{matrix}{w}_{11} & {w}_{12} & … & {w}_{1 k} \\ {w}_{21} & {w}_{22} & … & {w}_{2 k} \\ … & … & … & … \\ {w}_{n 1} & {w}_{n 2} & … & {w}_{nk}\end{matrix} ]$$

Each of the k weight vectors would define a BiPSA weight operator in conjunction with the b vector, yielding a BiPSA output b₀ⱼ for weight column wⱼ where j=1,2, . . . k.

The k BiPSA outputs would define a k element vector: b₀=b₀₁, b₀₂, . . . b₀ₖ

We can therefore use nominal matrix notation:

$$[ {b}_{01 ,} {b}_{02} … {b}_{0 k} ] = [ {b}_{1} {b}_{2} … {b}_{n} ] \times [ \begin{matrix}{w}_{11} & {w}_{12} & … & {w}_{1 k} \\ {w}_{21} & {w}_{22} & … & {w}_{2 k} \\ … & … & … & … \\ {w}_{n 1} & {w}_{n 2} & … & {w}_{nk}\end{matrix} ]$$

or in shorthand:
\vec{b₀}=\vec{b₁×}W

We can further define a series of BiPSA vectors: b₁, b₂, . . . bₘ and arrange them as a BiPSA matrix, B:

$$B = [ \begin{matrix}{b}_{11} & {b}_{12} & … & {b}_{1 n} \\ {b}_{21} & {b}_{22} & … & {b}_{2 n} \\ … & … & … & … \\ {b}_{m 1} & {b}_{m 2} & … & {b}_{mn}\end{matrix} ]$$

such that when multiplied by W, will yield a resultant matrix B*:

$$[ \begin{matrix}{b}_{11}^{*} & {b}_{12}^{*} & … & {b}_{1 k}^{*} \\ {b}_{21}^{*} & {b}_{22}^{*} & … & {b}_{2 k}^{*} \\ … & … & … & … \\ {b}_{m 1}^{*} & {b}_{m 2}^{*} & … & {b}_{mk}^{*}\end{matrix} ] = [ \begin{matrix}{b}_{11} & {b}_{12} & … & {b}_{1 n} \\ {b}_{21} & {b}_{22} & … & {b}_{2 n} \\ … & … & … & … \\ {b}_{m 1} & {b}_{m 2} & … & {b}_{mn}\end{matrix} ] \times [ \begin{matrix}{w}_{11} & {w}_{12} & … & {w}_{1 k} \\ {w}_{21} & {w}_{22} & … & {w}_{2 k} \\ … & … & … & … \\ {w}_{n 1} & {w}_{n 2} & … & {w}_{nk}\end{matrix} ]$$

or:

B*=B×W

Where:

b*ᵢⱼ=(bᵢ₁ bᵢ₂ . . . bᵢₙ)×(w₁ⱼ w_{2j . . . w}ₙⱼ)=[bᵢ₁,bᵢ₂ . . . bᵢₙ; w₁ⱼ, w₂ⱼ . . . wₙⱼ]

This formal match to nominal matrix algebra can be extended to the rest of the matrix expression. With BiPSA notation any two matrices where the number of rows in one is equal the number of columns in the other can be BiPSA multiplied. It is formally convenient to use the same N value for both the weight matrix and the BiPSA matrices, and thereby, for square matrices we may define an exponent, t:

$$\begin{matrix}{B}^{t} = [ \begin{matrix} {b}_{11} & {b}_{12} & … & {b}_{1 n} \\ {b}_{21} & {b}_{22} & … & {b}_{2 n} \\ … & … & … & … \\ {b}_{n 1} & {b}_{n 2} & … & {b}_{nn}\end{matrix} ] \times [ \begin{matrix} {b}_{11} & {b}_{12} & … & {b}_{1 n} \\ {b}_{21} & {b}_{22} & … & {b}_{2 n} \\ … & … & … & … \\ {b}_{n 1} & {b}_{n 2} & … & {b}_{nn}\end{matrix} ] \times \\ {… [ \begin{matrix} {b}_{11} & {b}_{12} & … & {b}_{1 n} \\ {b}_{21} & {b}_{22} & … & {b}_{2 n} \\ … & … & … & … \\ {b}_{n 1} & {b}_{n 2} & … & {b}_{nn}\end{matrix} ] }_{{⟷}_{t times}} \end{matrix}$$

Where the matrices are multiples from right to left, and the B matrix here represents the general matrix whether a “true B” (BiPSA values), or a “really a W” (weight values). We can further define a multiplication of an integer, z, and a matrix in the usual way:

$$z \times [ \begin{matrix}{b}_{11} & {b}_{12} & … & {b}_{1 n} \\ {b}_{21} & {b}_{22} & … & {b}_{2 n} \\ … & … & … & … \\ {b}_{n 1} & {b}_{n 2} & … & {b}_{nn}\end{matrix} ] = [ \begin{matrix}{zb}_{11} & {zb}_{12} & … & {zb}_{1 n} \\ {zb}_{21} & {zb}_{22} & … & {zb}_{2 n} \\ … & … & … & … \\ {zb}_{n 1} & {zb}_{n 2} & … & {zb}_{nn}\end{matrix} ]$$

and matrix addition:

$$\begin{matrix}[ \begin{matrix}{b}_{11} + {w}_{11} & {b}_{12 } + {w}_{12} & … & {b}_{1 n} + {w}_{1 n} \\ {b}_{21} + {w}_{21} & {b}_{22} + {w}_{22} & … & {b}_{2 n} + {w}_{2 n} \\ … & … & … & … \\ {b}_{n 1} + {w}_{n 1} & {b}_{n 2} + {w}_{n 2} & … & {b}_{nn} + {w}_{2 n}\end{matrix} ] = [ \begin{matrix}{b}_{11} & {b}_{12} & … & {b}_{1 n} \\ {b}_{21} & {b}_{22} & … & {b}_{2 n} \\ … & … & … & … \\ {b}_{n 1} & {b}_{n 2} & … & {b}_{nn}\end{matrix} ] + \\ [ \begin{matrix}{w}_{11} & {w}_{12} & … & {w}_{1 n} \\ {w}_{21} & {w}_{22} & … & {w}_{2 n} \\ … & … & … & … \\ {w}_{n 1} & {w}_{n 2} & … & {w}_{nn}\end{matrix} ]\end{matrix}$$

as well the ‘zero matrix’, Φₙ as a square matrix of size n where all elements are zero.

$${Φ}_{n} = \vert \begin{matrix}0 & 0 & … & 0 \\ 0 & 0 & … & 0 \\ … & … & … & … \\ 0 & 0 & … & 0\end{matrix} \vert$$

And also, the ‘unit matrix’, Iₙ as a square matrix of size n where all elements are zero except the ones along the major diagonal which are “1”:

$${I}_{n} = \vert \begin{matrix}1 & 0 & … & 0 \\ 0 & 1 & … & 0 \\ … & … & … & … \\ 0 & 0 & … & 1\end{matrix} \vert$$

It is readily seen that for any BiPSA matrix, B: B=B+Φ and: B=B×I=BI^{t} for any natural number t.

Assuming a square BiPSA matrix, A, the above defined matrix multiplication would lead to a power definition, as indicated above:
C=A^{k}=A*A*A . . . A (k times).

And from this, one would define:
A=C^{1/k}

And a corresponding logarithm:
k=log_{A}C

Because of the extreme reduction inherent in the BiPSA operation, these definition create very strong one-way function candidates. While it is easy and straight forward to compute C from A and k, to compute A from C and k, or k from C, and A, appears very laborious.

Now we may define a BiPSA polynomial of degree t:
aₜB^{t}+aₜ₋₁B^{t-1}+ . . . aₜB^{t}=Φ
with coefficients “a” as natural numbers. For each case as above there may be no solution for B, one solution or many.

The multiplication of matrices readily defines division: A=B/C (all matrices), if B=A×C, and hence one could write equations like:

$${( \frac{A + X}{B - {X}^{3}} )}^{2} - {AX}^{4} = 2 X$$

where A and B are known matrices, and X an unknown.

Any BiPSA network may be described either through matrix algebra or through network graphics. For example:

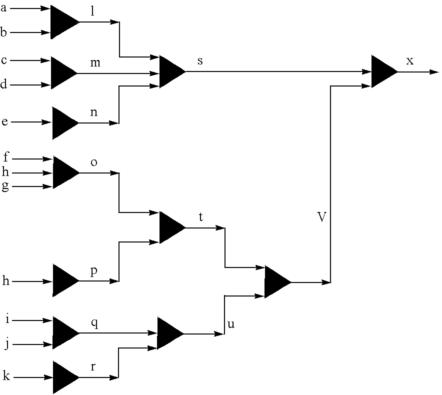

The network diagram above finds its equivalent in the following matrix notation:

$$( a , b , c , d , e , f , g , h , i , j , k ) \times [ \begin{matrix}1 & 0 & 0 & 0 & 0 & 0 & 0 \\ 1 & 0 & 0 & 0 & 0 & 0 & 0 \\ 0 & 1 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 1 & 0 & 0 & 0 \\ 0 & 0 & 0 & 1 & 1 & 0 & 0 \\ 0 & 0 & 0 & 0 & 0 & 1 & 0 \\ 0 & 0 & 0 & 0 & 0 & 1 & 0 \\ 0 & 0 & 0 & 0 & 0 & 0 & 1\end{matrix} ] = ( l , m , n , o , p , q , r )$$

Following with:

$$( l , m , n , o , p , q , r ) = [ \begin{matrix}1 & 0 & 0 \\ 1 & 0 & 0 \\ 1 & 0 & 0 \\ 0 & 1 & 0 \\ 0 & 1 & 0 \\ 0 & 0 & 1 \\ 0 & 0 & 1\end{matrix} ] = ( s , t , u )$$

$$and then \text{:}$$

$$( s , t , u ) \times [ \begin{matrix}1 & 0 \\ 0 & 1 \\ 0 & 1\end{matrix} ] = ( s , v )$$

$$And finally \text{:}$$

$$( s , v ) \times [ \begin{matrix}1 \\ 1\end{matrix} ] = x$$

$$Combined \text{:}$$

$$\begin{matrix}( a , b , c , d , e , f , g , h , i , j , k ) \times [ \begin{matrix}1 & 0 & 0 & 0 & 0 & 0 & 0 \\ 1 & 0 & 0 & 0 & 0 & 0 & 0 \\ 0 & 1 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 1 & 0 & 0 & 0 \\ 0 & 0 & 0 & 1 & 1 & 0 & 0 \\ 0 & 0 & 0 & 0 & 0 & 1 & 0 \\ 0 & 0 & 0 & 0 & 0 & 1 & 0 \\ 0 & 0 & 0 & 0 & 0 & 0 & 1\end{matrix} ] x \\ [ \begin{matrix}1 & 0 & 0 \\ 1 & 0 & 0 \\ 1 & 0 & 0 \\ 0 & 1 & 0 \\ 0 & 1 & 0 \\ 0 & 0 & 1 \\ 0 & 0 & 1\end{matrix} ] \times [ \begin{matrix}1 & 0 \\ 0 & 1 \\ 0 & 1\end{matrix} ] \times [ \begin{matrix}1 \\ 1\end{matrix} ] = ( x )\end{matrix}$$

Application Oriented Constructs and Procedures

We consider the following application categories:
uncertainty handling
cryptography and computability
complexity theory
   .BiPSA Uncertainty Handling
   .BiPSA Uncertainty Handling Environment

BiPSA Principals:
A matter of uncertainty (MOU)
Client
Operator
Client-Operator Transaction (COT)
BiPSA Operation
Binary Cascade of the MOU
BiPSA Cascade Processing (BCP)
a BiPSA Question (BQ)
BiPSA setting
BiPSA Response Team
BiPSA Integration Network
BiPSA Communication System
BiPSA Issue Processing
The Recursive nature of BiPSA
   Uncertainty Handling with BiPSA

We introduce the following concepts:
Momentum
Cross Issue Reconciliation
multi variate voting (MVV)
ranking
mapping back/forth vs. traditional expressions
Multi-factored distance metric
   .Momentum

The output of the BiPSA Unit Integrator is limited to the range of the input variables, namely: {−N:+N}. The advantage of this design has been made clear earlier, allowing for an infinity of networking to be constructed. Albeit, the same limitation deprives the reader of the BiPSA output from any information regarding how many input variables produced that result, and what was the distribution of their values.

This deficiency is taken care of through the notion of BiPSA momentum.

To define momentum we must first define the notion of confidence points. For a BiPSA voter the ordinal value of his vote is his confidence count, or confidence point. For a BiPSA setting we define the positive confidence points (CP+) as the sum of confidence points of all voters who voted in the positive, and similarly define the negative confidence points (CP−) as the sum of confidence points of all the voters who voted in the negative.

Hence for [4,−2,0,1,1,−3] the positive confidence points count as CP+=6=4+1+1, and the negative confidence counts count as: CP−=−2+(−3)=−5.

We also regard positive confidence point as minus negative confidence points, and vice versa. And so we may define the Net count of positive points (NCP+) as:

NCP+=(CP+)−(CP−)

And similarly the net negative confidence points, NCP− as:

NCP−=(CP−)−(CP+)

Clearly:

NCP+=−NCP−

Finally we define the BiPSA confidence count (BCC) as the net count of positive points for a positive BiPSA outcome, and as the net count of negative points for a negative BiPSA outcome.

Note that these definitions apply for a unit integrator or a full blown network. But to make sense of these values, one will have to identify the integration configuration it refers to.

Generally when the BiPSA confidence count increases, the BiPSA result moves “up” (away from zero, away from neutrality), and when the BiPSA confidence count decreases the BiPSA result moves “down” (towards zero, towards neutrality). The term “move” here includes “zero move”.

Consider the BiPSA setting: 1=[4,2,−2,1,−3,0,1]. If we were to increment the BiPSA confidence count by 1, then no matter which variable we will increment the BiPSA result will be higher or equal to the original result, but never lower.

If we were to add 2 confidence points to the BiPSA confidence count we would have many more options to distribute these points over the voter's values (C²₇+7 to be exact), but the condition of monotony would guarantee that under no circumstance the BiPSA result comes down.

We may now ask: for a given BiPSA setting what will be the minimum increase in the BiPSA confidence count that if favorably distributed would increment the BiPSA result (by one or more). This increase will be regarded as the up-momentum of the BiPSA setting. Say:

|b₀(BCC′)|>|b₀(BCC)|

Where BCC′=BCC+ΔCP

The lowest value of Δ CP that would be consistent with the above equations is regarded as the up-momentum of that BiPSA setting. (Mu)

Respectively we may define the down-momentum of a BiPSA setting as the minimum count of confidence points that would decrement the BiPSA result, (Md)

We may define two additional types of momentum:
Nominal Momentum
Complementary Momentum
   Nominal Momentum

We pose the following question: given a BiPSA setting, with a single output {−N:+N}. What is the smallest number of confidence points that should be subtracted from the n inputs to change the output to zero, or to the opposite answer?

Let BCC_{before} be the BiPSA confidence count before its decrement, and let BCC_{after} be the count after the decrement, then we search for the smallest confidence drop, Mo:

Mo=MIN (BCC_{before}−BCC_{after}

Such that

|b₀(BCC_{before})−b₀(BCC_{after})|≧|b₀(BCC_{before})|

For a drop of Mo−1 confidence points there is no way that the BiPSA result would drop to zero or to the opposite side.

The value Mo is called the Nominal Momentum of the BiPSA setting, or simply the momentum. The higher its value, the more “effort” is needed to drop down the confidence measure of the voters in order to neutralize the BiPSA result, or to switch it to the opposite side.

We may complement this definition by the notion of the conjugate momentum, defined as the smallest number Mo* of drop of BiPSA confidence points that can not be applied without causing the said switch.

The subtle distinction between M and Mo* is that the first is the count of confidence point drops that would cause a result switch if one tries to achieve it, and Mo* is the count, if one tries to prevent it.

We have: Mo≦Mo*

The gap (Mo*−Mo), the momentum gap, is a third attribute of the BiPSA setting.

Consider the two cases below:
i.3=[4,1]
ii. 3=[3,3,3,3,3,3,3,3,3,3,3,3,3,3,3,3,3,3,3,3,3,3,3,3]

While their BiPSA output is the same, the input sets that generated the result is quite different. Indeed the two BiPSA settings above have quite a different momentum attribute.

Mo(i.)=Mo([4,1])=5

Mo(ii.)=Mo([3,3,3,3,3,3,3,3,3,3,3,3,3,3,3,3,3,3,3,3,3,3,3,3])=39

In case (i.) the switch will happen by dropping the confidence points: [4,1] to [0,0], which computes to 4+1=5. In case (ii.) 13 variables will have to be dropped each from 3 to 0:

[0,0,0,0,0,0,0,0,0,0,0,0,0,3,3,3,3,3,3,3,3,3,3,3]=0

which amounts to 3*13=39.

One may note that in case (i) alternatives process would be:

[4,1]−−>[4,−4], [3,−3], [2,−2], [1,−1], but the results are the same Mo=5.

For case (ii.) one may check another option:

[−1,0,0,0,0,0,0,0,0,0,0,0,0,3,3,3,3,3,3,3,3,3,3,3]=0

for which Mo=40. So since Mo=39 can be distributed across the input variables so that the switch occurs, it figures then that Mo=39.

One readily observes that Mo*(i.)=Mo(i.)=5, but for case (ii.) there exists a big momentum gap. The input vector can be dropped to:

[−8,−8,−8,−8,−8,−1,−1,−1,−1,−1,−1,−1,1,1,1,1,1,3,3,3,3,3]

for N=8, and hence Mo(ii.)=106

Below we define the notion of the momentum ratio, and momentum computation techniques.

.Momentum Ratio

One may be interested to capture the momentum per an individual input count. To that end we may define the momentum ratio, Mr, as:

$${M}_{r} = \frac{M}{nN}$$

where n is the number of BiPSA input variables, and N is the ordinal limit. It is clear that: 0≦Mr≦1.
.Momentum Computation Techniques

Momentum computation is not straight forward. One can readily drop Mo′ confidence points form the input set and show that such drop causes a binary switch, or a neutral switch, but then one has to prove that the drop count is such that for any smaller count there is no way to cause that switch. Or, the conjugate momentum to show that for any larger count, it is impossible to prevent the switch.

For the unit integrator one could apply some straight forward logic, with regard to, say, reducing the confidence of the most confident variables, but for a network, one has to study the particulars of the network to compute the momentum.

It is always possible to use “brute force” namely: for any value of drop count (Mo candidate), to try all possible distributions. The various BiPSA results would clearly point out Mo and Mo*.

.Complementary Momentum

Given a BiPSA setting and its output, M, such that |M|<N one may ask what would be the least amount of added BiPSA confidence count that would transform the BiPSA summary to N for M>0 or −N for M

Let BCC_{before} be the BiPSA confidence count before its increment, and let BCC_{after} be the count after the increment, then we search for the smallest confidence boost, CM:

CM=MIN (BCC_{after}−BCC_{before})

Such that

|b₀(BCC_{after})|=N

For a boost of CM−1 confidence points there is no way that the BiPSA result would reach its maximum rating, N or −N.

.Hop Momentum

The various momentum entities may be generalized as follows:

Given a BiPSA setting with a BiPSA summary of b₀ (before) and a reference BiPSA summary b₀ (after). Let CP be the minimum count of confidence points that would effect this change. We shall define CP as the “hop momentum” from state “before” to state “after”.

CP=MIN (BCC_{after}−BCC_{before})

For a given pair of (b₀(before), b₀(after))

We shall define the hop momentum ratio, Mr as follows:

$${M}_{r} = \frac{CP}{n ( {b}_{0} ( before ) - {b}_{0} ( after ) )}$$

for all cases where (b₀ (before)≠b₀ (after). n is the number of input variables.
Cross Issue Reconciliation

BiPSA itself is a procedure of reconciliation among inconsistent opinions over a given issue. The question arises in the case where two or more BiPSA questions are related via some high validity rule. When the rule is applied to the BiPSA results of these issues, it is found violated. The question now is how to resolve this cross-issue inconsistency.

For example let one BiPSA issue be: “Would it rain all day tomorrow?” and the other BiPSA question is: “Would the team finish the outdoor project working from morning to nightfall tomorrow?” These questions are distinct, of a different realm, but they may be associated by a rule, like: “no work is allowed on a rainy day”. If that rule comes with a strong validity, and must be obeyed then it is clear that one might face a cross-issue reconciliation challenge should the BiPSA answers for the two questions be “yes”. Obviously there are possibilities of subject matter reconciliation. The BiPSA operator would make sure that the project team knows about the prediction of the rain team. One might think of a tent to work under, or one might theorize that the rain will be intermittent, so work periods can be accomplished, etc. If such reconciliation works out, all is good. We are left with the question of resolving such inconsistencies once all these subject-matter avenues have been exhausted.

It all comes down to a question of credibility. If the “rain team” is more credible than the “project team” then one would conclude that it would rain tomorrow, and by force of the no-work-in-rain rule, no work would be done on the project, and hence, it would not finish. In other words: the conclusion of the project team is overruled. There are two main methods to effect cross-issue reconciliation:
The super-team approach
Momentum comparison
   .Super-Team Cross-Issue Reconciliation

One could resolve this credibility issue by applying BiPSA via a third team that would wrestle with the following BiPSA question: “If the rain-team and the project-team clash as above, who would prevail?” While this would formally resolve the dilemma, it must be treated with caution. What we have done with the third BiPSA question is spread the inconsistency into a three-way situation. Is the third team more credible than the first two? Now, one could attack this question with a forth BiPSA issue: “Is the third team qualified to resolve a conflict between the first two?” Alas, this extends the dilemma to a four-way inconsistency, and so on. This route would only be productive if there is a super-team that is qualified to rank order the two teams on conflict. If there exists such a super BiPSA team then the dilemma is forthwith resolved. The higher credibility team prevails.

.Momentum Based Cross-Issue Reconciliation

In the absence of such a “super BiPSA team” one would resort to momentum computation to resolve the conflict.

Given two distinct BiPSA settings:

b₀=[b₁, b₂, b₃, . . . bₙ]

b′₀=[b′₁, b′₂, b′₃, . . . b′_{n′}]

such that:

|b₀+b′₀|<|b₀|+|b′₀|

And given a high credibility rule that dictates:

|b₀+b′₀|=|b₀|+|b′₀|

one would compute the nominal momentum of each BiPSA setting, Mo, and Mo′ and resolve this cross-issue inconsistency as follows:
if Mo<Mo′ then one would adjust b₀=0 and leave b′₀ unchanged
if Mo′<Mo then one would adjust b′₀0 and leave b₀ unchanged.
if M′=M then one would adjust b′₀0 and b₀=0

In other words: the BiPSA result that comes with less momentum would be overruled for sake of resolution of that cross-issue conflict.

Applicability of Momentum Based Reconciliation

This method of reconciliation would apply in cases where the two BiPSA settings have voters that are either not cross rated with respect to credibility or are rated more or less equal. One can envision a situation where the same sources participate in both BiPSA questions. it may be that for each such double participator, his or her own answers would be cross-issue consistent, but the integrated answers would exhibit a conflict.

.Multi Factored Decision

We consider the case where a BiPSA decision needs to be evaluated on the basis of n factors, f₁, f₂, f₃, . . . fₙ.

In that case one would have first to list these factors, and then assume that every factor issues its own BiPSA opinion, and these opinions then need to be integrated into a most credible summary.

This integration can be done ad-hoc, according to the BiPSA planner's understanding of the relative impact of the various factors. The integration can also assume a standard procedure as follows:

The n factors are first BiPSA ranked, as described above, where the lowest factor (by impact or importance rating) is assigned the number 1, and the rest climb from there. This assignment will then define an extended BiPSA case where the BiPSA ranking would be the extended-BiPSA impact factors. The result would reflect the intended relative impacts of these factors.

Alternatively one could select the following procedure:

The BiPSA ranking defines the added ordinal value of each ranked option over its former, but no absolute values. According to the nature of the issue at hand, the impact value should be positive, and thus we have seen above that the lowest option was arbitrarily defined as one. Now once could choose to assign the number 1+a, to the first option where a=0,1,2,3, . . . and the upper options will be rank-specified accordingly. Each value of a would define a new extended-BiPSA case, or say, a new column in the BiPSA matrix. Choosing, say a=0 to a=10, one would generate 11 BiPSA results, which can be BiPSA integrated to yield the final BiPSA opinion.

Now what is left is to generate the per-factor BiPSA opinion. This can be done by searching for BiPSA respondents with credentials regarding these n factors. For each respondent j with respect to factor i one would use an ordinal indicator for credentials. Let this credentials indicator run from 0 (no credentials) to V (maximum credentials). Now in order to develop the summary opinion of factor i one would compute the extended BiPSA with respect to the various BiPSA respondents associated with their respective credentials indicator for that factor. This procedure would allow the various sources to line up for each factor according to their respective credentials for the same.

Also this procedure would alert the BiPSA operator to any deficiency with respect to required wisdom with regard to any relevant factor. If a given factor does not have any respondent with credentials of V, then it may not be properly represented in the combined wisdom of the BiPSA team.

.Mapping BiPSA Results to and from Traditional Expressions

The BiPSA results can often stand on their own, but at times the need arises to map these results to the more traditional forms of expression. Similarly one may wish to map traditional expressions into BiPSA results.

Cases in point:
mapping BiPSA to probability curves
mapping BiPSA to margins of error
   .Mapping BiPSA to Probability Curve

The most prominent case for this challenge is the one where BiPSA results need to be translated into the more traditional probability curve.

We consider a variable X that assumes the value X0 for a given situation. Alas X0 is not known, and must be estimated. The estimate of X is scientifically expressed through its probability curve drawn on a plane with the horizontal axis indicating the quantity of X, and the vertical axis indicating probability, so that the curve f(x) would be such that for any two estimated amounts x1 and x2 (x2>x1) the probability for the true value X0 to be in that interval, namely: x1≦x0≦x2 is given by:

P(1−2)=∫f(x)dx from x1to x2

This probability curve is a favorite of theoreticians, and a frequent frustration for practitioners, since f(x) is hard to come by.

We will show below how to generate f(x) the BiPSA way.

Procedure:
1. Pick a value of interest x1
2. Run a BiPSA session with respect to x1.
3. Construct a 2N+1 histogram to approximate f(x)
4. Redo steps (1-3) k times

When done this procedure would achieve a histogram of k(2N+1) columns that would approximate f(x) as closely as desired.

Pick a Value of Interest, X1

The picked value can be a random choice for the procedure to work, albeit one often can identify a case of interest that divides the range of possibilities to two consequential zones.

2. Run a BiPSA Session

Once the value of interest x1 is picked, the BiPSA operator would have to assemble a team of BiPSA respondents, build their integration matrices, and run a BiPSA session on whether the value of x is above or below the value of interest xl. The BiPSA result will appear in the form of {−N:+N}.

.Construct a 2N+1 Column Histogram

This step would be accomplished using the notion of “BiPSA dwarfs”.

We envision a large number of dwarfs with some knowledge of the situation. Each dwarf develops his own estimate of x. When one polls this community of dwarfs and files their answers in some intervals of x, one can then count how many dwarfs estimates an x value to fall within a given interval. Based on this tally one would build a histogram that would evolve into the x probability curve. In other words, the x probability curve is a summary of the answers of the many relevant dwarfs.

We would now assume that the same dwarfs were polled in the BiPSA question with respect to whether the value x0 is above or below x1.

We now need a procedure to develop the BiPSA answer of a dwarf who believes that the best estimate for x0 is y. That answer would logically be driven by the gap |y−x1|.

Suppose a positive BiPSA answer would mean that the respondent believes that x0>x1, and a negative BiPSA answer means that the respondent believes that If x0<x1. logically, if y<<x1 the dwarf would answer a high confidence negative, and if y>>x1 the dwarf would answer a high confidence positive.

We can then map the x range in some arbitrary way to say:
If x1≦y≦x1+a1 then the dwarf would BiPSA respond as +1
If x1+a1≦y≦x1+a2 then the dwarf would BiPSA respond as +2
If x1+a2≦y≦x1+a3 then the dwarf would BiPSA respond as +3
. . .
. . .
If x1+a(n−1)≦y≦x1+an then the dwarf would BiPSA respond as +N
   where a(i) are positive values.

Similar boundaries would be drawn for the dwarf to vote: −1,−2, . . . −N.
If x1≦y≦x1−b1then the dwarf would BiPSA respond as −1
If x1−b1≦y≦x1−b2 then the dwarf would BiPSA respond as −2
If x1−b2≦y≦x1−b3 then the dwarf would BiPSA respond as −3
. . .
. . .
If x1−b(n−1)≦y≦x1−bn then the dwarf would BiPSA respond as −N

Based on this mapping one would be able to map a probability curve to a BiPSA answer with respect to X1. Since the BiPSA answer is given (from the BiPSA respondents assembled by the BiPSA operator) it becomes then a mathematical exercise to find a probability curve that would produce the same answer.

Specifically one would construct a 2N histogram in the following intervals:
(x1−b(n−1)) - - - (x−bn) with area Bn
. . .
x1−b1 - - - x1 with area B1
x1 - - - x1+a1 with area A1
x1+a1 - - - x1+a2 with area A2
. . .
. . .
x1+a(n−1) - - - x+an with area An

Let b0 be the BiPSA answer from the BiPSA actual respondents with respect to x1. We now can construct the following BiPSA equation:
b0=[−N, . . . −N, (N−1),−(n−1), . . . ] An times . . . A(n−1) times . . .
which is a single equations with 2N variables. It may have many solutions. By convenience we may select the most ‘flat’ solution as the solution of choice.

At will one would modify the above to construct a small interval around x1 (x1−b0) to (x1+a0) with the stipulation that any “dwarf” with an estimate within this interval will issue a +0 BiPSA opinion, and in that case the histogram would contain 2N+1 rather than 2N columns.

.Interval Setting

One must admit that the above process involves an arbitrary choice of interval boundaries, namely: a0, a1, a2, . . . aN, b0, b1, b2, . . . bN.

We may analyze this arbitrariness through the following cases:
1. BiPSA point with two infinite intervals,
2. BiPSA point with one infinite interval.
3. BiPSA range.
   .Redo Histogram Procedure

The BiPSA operator could run the above procedure over another value of choice for x, say x2. This would define 2N+1 new intervals over X, and the BiPSA result will be resolved to define the sizes of these new 2N+1 columns. Since the new 2N+1 columns divide the same x zone that was divided by the first 2N+1 columns, one can then define up to 2(2N+1)−1 columns in the same zone. The actual number of columns may be somewhat smaller if one or more intervals of one BiPSA round are fully contained in an interval of another round.

By repeating this procedure k times with respect to x₁, X₂, X₃, . . . xₖ BiPSA values, one would build a probability histogram of about k(2N+1) columns which would approximate the probability curve to any desired degree.

Ranking

Inverse Ranking

Inverse ranking is a procedure through which the high-ranked becomes low ranked and vice versa. It is defined over a same sign rankings only. given n ranked entities, with ordinal ranking R₁, R₂, R₃, . . . Rₙ the corresponding inverse ranking: R*₁, R*₂, R*₃, . . . R*ₙ is defined as follows:

R*ᵢ=Max{Rₙ}+1−Rᵢ

Hence if the original ranking is: 4,1,2,3,0 then the inverse series would be: 1,4,3,2,5

Multi-Factored Distance Metric

We consider the following case: two entities A and B are each defined through f₁, f₂, f₃, . . . fₖ factors. The two have some equality of values for some factors, and inequality of values for others. The question to be answered is how close are these two entities to each other?

This closeness would be expressed through some distance function D(A,B) which would be used to assess proximity of one couple of entities versus the proximity of another. We shall discuss below the common way of measuring distance, then present the BiPSA way.

The Common Way to Express Multi-Factored Distance

The common way is to construct a k-dimensional space, with a unique dimension for each of the relevant k factors. On such a space the two entities are expressed as a multi-dimensional point each. These two points define a mutual distance drawn on the same k-dimensional space. That distance is taken to reflect the distance between the two entities. This solution is considered attractive because it allows for all the factors to contribute to the distance value.

Mathematically this method requires an arbitrary decision regarding the relative size of each dimension. Also, as the number of dimensions increases the computation burden increases too, and at some point this burden become untenable.

BiPSA Multi-Factored Distance

Procedure:
1. Process the k factors into k* binary oriented factors.
2. Define a BiPSA scale for each of the k* factors.
3. Express the values of A and B for each of the k* factors.
4. List the absolute differences per each of the k* factors.
5. Rank-Order (the BiPSA way) the k* factors.
6. BiPSA process the list in (4) with the ranking in (5) as impact factors.

The result of (6) is the distance measure between A and B.

.Process the Original Factors into Binaries

Some factors are natively binary (yes/no). Others refer to variables ranging between a low value, L, and a high value, H. The latter can be defined as a series of binary attributes, like:

Let L<M<H. The binary attribute may be: does the value of this variable range between (L-M) or between (M-H)?

Binary questions are then BiPSA answered, where the greater the distance from M, the higher the BiPSA confidence measure.

If a greater resolution is desired, it is possible to define a second question. Let L<P<M, the respective binary question would be, is the value of the variable higher, or lower than P. Similarly, any number of cutting points may be defined as a unique attribute.

Define a BiPSA Scale

Each factor of the K* binary ones would be defined so that for any value of each factor it would be clear how to map it to the range {−N:+N}, where N is the same for all the factors.

.List the Absolute Differences

These differences range at {0:+2N}. The subsequent BiPSA computation will be ranging in the same range.

.Distance Based Factor Integration

The BiPSA answers of the k* factors need to be integrated according to the rank order of these factors.

The BiPSA Components

The major components of the BiPSA procedure are:
1. BiPSA binarization
2. BiPSA sourcing (dwarfing)
3. BiPSA integration
   .BiPSA Binarization

This is the process by which an issue of learning is defined through a cascading series of binary questions. The questions generally may be described as a concentric breakdown of the issue, using the termination expressed in the book “The Turing Machine”.

Binarization of issues is not very strict, or generalized, and there is plenty of room for improvisation. Some special cases are discussed below.
1. resolving a function, y=f(x)
2. finding a function, y=f(x)
3. addressing a complicated, multi-faceted issue.
4. R&D effort (The Innovation Turing Machine).
5. binarization for data generation purposes.

It is generally advisable for a binary question to be time limited and so phrased that when its time is up, there is no ambiguity as to the correct binary answer. This is because such resolved binary questions are very useful and important for refining and improving the BiPSA integration network for related (still unresolved) questions.

Resolving a Function

The recurrent challenge of solving a function y=f(x) may be expressed as a binary cascade as follows:

One searches for a value x=u, such that f(u)=0, where x is allowed within a range of a low value, L, and a high value H.

The first binary question would be: is it true that L≦u≦M where M is an arbitrary choice such that L≦M≦H. The simplest assignment is M=0.5(L+H). If the answer is yes, then the question may be repeated with the new assignment of the highest boundary of the range for u being M (H′=M). If the answer is no, then the question may be repeated with the new assignment of the lowest boundary of the range for u being M (L′=M). This repetition can be exercises as many times as desired, gradually limiting the interval for u until it is sufficiently narrow for the purpose at hand.

This procedure is readily extended to a multi variate function.

.Finding a Function Y=F(X)

The shape of a function y=f(x) may be established as follows:

Let {x=L,x=H} be the lowest and highest points for the range of x. For any given point M such that L≦M≦H ask:

Is the value of ∫y(x)dx from L to M higher than some threshold T? If the answer is yes than repeat the same question with M′<M, (but close to M), until one finds some value M⁽ⁱ⁾ such that the answer is “no”. This would lead to the conclusion that

∫y(x)dx from L to M⁽ⁱ⁾=T

Now one can construct a histogramic rectangle of height T between L and M⁽ⁱ⁾. If the original answer is “no” then one would ask the same questions again with a higher level T′>T. or repeat the sequence with respect to the interval {M:H}.

This technique of creating a histogramic rectangle may be repeated for any x interval from L to H, and with sufficiently small intervals the histograms would chart the function y=f(x). This technique can be readily extended to the multi-variate case.

Addressing a Complicated, Multi-Faceted Question

Such questions can generally be expressed through a cascade pattern as follows:
1. is the question decidable? (yes/no)
2. can it be satisfied within a given set of limited resources, S? (yes/no)
3. can it be satisfied subject to a given set of constraints, C? (yes/no)
4. can it be satisfied through some given solution plans? (yes/no)
5. will the first phases of a given solution plan be accomplished? (yes/no)

Binary questions of type (2) above may be developed to many questions, each citing a different level of available resources. The same for type (3) with respect to any combination of constraints.

Type (4) may be also be further cascaded by first referring to a set of solution plans, then narrowing the question down to a single plan. Finally, the questions may be repeated for increasingly well-defined (more detailed, more refined) solution plans.

Type (5) questions may also be developed into any combination of some individual phases in any solution plan.

These distinct types of questions may also be combined in various ways. So one can ask if plan A at refinement level x will satisfy the original issue when operating under a given constraint, with some limited resources.

By formalizing a question with respect to some detailed plan, it is possible to introduce all the fine points of a solution and package it ready for a yes/no answer.

.Binarization for Data Generation Purposes

The BiPSA integration process would benefit from credibility data regarding its sources. Such data can be garnered from feedback with respect to similar BiPSA questions responded to by the same or similar sources. One would then develop such BiPSA questions for a quick feedback to help a related and important BiPSA issue. [image] This data generation binary issues, for instances, can be carried out with respect to a given long term project, by asking binary questions with respect to more immediate milestones within that project. When the time for such milestone arrives, that issue generates a reality-check feedback, which would then help modify the BiPSA integration process for the full project BiPSA question.

BiPSA Sourcing

This is the process in which one assembles opinions sources with respect to the current binary question.

The first division of such sources is:
Human sources
Non-Human sources
   .Human Sources

Any binary question may be posed to any human being. That person would then use whatever he likes, or chooses: data, theories, models, faith, beliefs, intuition, extra sensory perception—it's up to that individual. The result is a binary answer.

Non-Human Sources

These are combinations of data and arbitrary input (theories, models) that operate on that data to produce a binary BiPSA conclusion.

In a way we have here the repeat of the familiar D+A→C, but the difference here is that the conclusions are only an interim step in the learning process, prior to their integration.

Let g be a conclusion generating theory operating on data D to produce BiPSA conclusion C. The further D is from C, the more ambitious and daring should g be.

The BiPSA process is outreaching. So any faintly reasonable theory g would qualify, creating a combination [D-g] that works, as described, like a BiPSA dwarf that expresses its opinion with respect to the binary question of interest.

BiPSA Integration

This is the process by which one integrates the expressed opinions of the BiPSA sources. BiPSA integration operates according to the steps outlined and defined in the BiPSA mathematics.

[image]

The integration process is the heart of a BiPSA. We shall address it from a philosophical standpoint, and from practical angles.

BiPSA Integration: Visibility

The mathematical definition of integration parameters tend to be complex obscure. As a result the ultimate user may not have a direct indication of how exactly the integration parameters interact. Such common shortcoming is avoided with BiPSA. The BiPSA matrix algebra may be mirrored through an easy to decipher networked configuration.

.Monte Carlo BiPSA

It is easy and straight forward to practice the Monte Carlo procedure over any BiPSA integration. Each of the input variables will be assigned a random value taken from its value probability histogram, and each combination of input would be integrated to produce the output result. The aggregating output values will form the output probability histogram.

.Reintegration

Given a BiPSA environment where a BiPSA set is subjected to same type questions, there is an incentive to reform the integration process to increase the credibility of the result. The factors that would influence such re-integration are:
1. external case information.
2. voting pattern
3. reality check

From one question to another, the situation manager may have a chance to learn something new, and this new knowledge that comes outside the BiPSA experience might dictate a change in the integration configuration. The BiPSA process generates voting data, which is telling a bundle about the BiPSA respondents (the BiPSers). That insight might influence re-configuration of the integration process. The most powerful force for re-integration is, clearly, feedback data with respect to the hit-or-miss of the former questions. The latter will lead the configuration manager to boost the role of the consistently correct, and consistently incorrect (with reverse sign) BiPSers, and diminish the role of BiPSers which are at random with the reference results. The three categories of factors work together.

.Re-Integration Through External Factors

In a factored BiPSA the situation manager might learn about new factors, or find out a different relationship and relative influence of existing factors, leading him or her to re-draw the configuration lines. One can find information with regard to the BiPSA respondents, say, their honesty, or the accuracy of their claimed credentials. Also, in a commercial setting where the BiPSA operator is paying the BiPSA respondents, some such respondents may have upped their demands and become unaffordable.

Voting Pattern Re-Integration

One could opt to use voting history to improve the integration process. Given n BiPSA respondents, there is a question in mind with regard to how to best integrate them. If two voters, A and B vote the same, or similarly, then if these two voters were to be integrated into a single vote that would be further integrated in the larger configuration, then one of them may be superfluous. That means that in a commercial setting where voters are costly, the BiPSA operator might drop one of them to save expenses. If cost is not an object then it would make sense to avoid early integration of these two, and cast each of these two voters against some other voters that exhibit a much different voting record. This way the voting conflicts will sort themselves out early in the integration process. One needs, therefore to develop a procedure that would accomplish such preference. Several may be considered, among them “The Electric Model”, so called because it uses a formula reminiscent of Coulomb law.

.The “Electric” Model

In this model the BiPSers (BiPSers are BiPSA voters) are placed on an Euclidean space, and their position there is determined by their respective voting record. Integration is driven by cluster forming by these BiPSers. Generally, every two BiPSers experience a mutual “force” of the magnitude of:

$${F}_{ab} = \frac{{V}_{a} {V}_{b}}{{d}_{ab}^{2}}$$

where Vₓ is the voting of BiPSer x, and d_{ab} is the distance between BiPSers A and B prior to the latest vote.

F_{a,b} is the mutual force between BiPSer a and BiPSer b. If F is positive, the BiPSers attract each other; if F is negative they repel each other.

For each BiPSer in the set one would add all the forces experienced by it (vectorially), and the resultant vector will determine the direction in which the BiPSer would move, while the distance in that direction would be proportional to the magnitude of the resultant force.

The space where the BiPSers reside may be open-ended, or closed. The latter will foster clustering. The initial positioning of the BiPSers would be non-discriminatory, namely that all BiPSers are at equal distances from each other.

We shall further elaborate on implementing the electric model over a one dimensional space, and on how to translate the evolving clustering into re-integration.

Reality Check

When an external source eventually determines the correct result of a BiPSA question then the voters divide to those who voted correctly vs. those who voted incorrectly. This division may be used to re-allocate influence to the community of BiPSA voters. There are numerous ways to accomplish that.
1. The graded method
2. The scaled method

In the graded method the main configuration is repeated 2N additional times, and all the 2N+1 BiPSA results are integrated to a final output. The 2N configurations are defines as follows: For i=N,−(N−1),−(N−2), . . . 1 collect all the voters which were correct according to the reality check, and voted at confidence level i or above. For j=−N,−(N−1),−(N−2), . . . −1 collect all the voters excluding those who were wrong and voted at a level of confidence j or above.

In the scaled method is based on associating each BiPSer with a scale that represents its hit-value. The scale is constructed in the following way: each BiPSer starts with a hit value of zero. For every BiPSA question where the BiPSer was correct the hit value is incremented with the confidence level of the vote. For every BiPSA question where the BiPSer voted incorrectly the hit value is decremented with the confidence level of the vote. Over time, the BiPSers that claim a high hit-value gain more weight, perhaps, commensurate with their hit value. The BiPSers with the lowest hit value are endowed with a negative high vote, and the ones that remain the closes to zero, may even be dismissed as worthless.

Applications

The BiPSA methodology is based on a reduction arithmetic, which leads to applications in the vast learning and inferential business, as well as in situations where the reductionist nature of BiPSA has other uses, for instance: one way functions for cryptographic use. The visibility and flexibility of the BiPSA integration leads to applications where groups and communities need to integrate their spectrum of opinions in a ‘fair and balanced’ way. The first division of BiPSA applications is according to the nature of the sources.

Applications based mainly on people respondents would be one category, and those based mainly on data dwarfs would be a second category.

The following outlines a partial list of the vast realm of BiPSA applications.

The BiPSA Genetic Model

A genetic model features an improvement of performance through reproduction and reassembly.

Several models: unitary parent ship .nonunitary parent ship

.NONUNITARY PARENTSHIP These are models where the off spring is a result of merger of at least two parents. We envision here: .the coupleship model .the multiple parent model

.THE COUPLESHIP MODEL This model works as follows: Given n Voters, one would run a training session, at which end one would rank the Voters according to their hit to miss ratio. The first ranked Voter will BiPSA couple to form an off spring, according to their ranking values perhaps. The first and the third ranked Voters will also couple, the first and the fourth, the second, and the third etc.

Also some coupleships will be formed at random regardless of ranking. This would form a new set of Voters that would undergo another training session, where new offspring will be defined. And so on. To accommodate computation limitation, the least ranked Voters can be eliminated from the set, keeping the number of Voters computable

BiPSA and Nominal Probability

BiPSA, when used to handle uncertainty, is naturally linked to the more common constructs found in the realm of probability calculus. In this section we address this linkage. Let b(e) be the integrated BiPSA value associated with event e. That is, a BiPSA operator queried his available sources about the eventuality of e, and computed b(e) as the result. Probability calculus associates the prospect of event e to occur with a probability measure p(e). The value of p(e) is linked to the point of view, or the knowledge available to the entity that computes and asserts that value. Thus, if Peter hides a coin under his palm, then for Pall the probability of “heads” is 50%, while for Peter it is either 0% or 100%. Hence, in order to complete the definition of p(e) one must specify what source of knowledge it is based on. In our discussion we shall assume that the body of knowledge on which a certain value of p(e) is based, is exactly the body of knowledge used to derive the corresponding BiPSA value from. And by that we establish a necessary link p(e)−b(e). This simple statement is not without its complications. Whatever knowledge, theory, or logic that produces the value of p(e) should also be a BiPSA respondent for the question of the eventuality of e. And if that source is compelling then the BiPSA integration network should give it the priority, and the integrated BiPSA value should be the one corresponding to p(e). This allows one to establish an arbitrary scale: p(e)−b(e), confined only the monotony requirement: for every two events, e, and e′, if b(e)>b(e′) then p(e)>p(e). This requirement does not work in the reverse because p is on a continuous scale, and b on a discrete one.

Let S be such an arbitrary scale that maps BiPSA values to probabilities and vice versa. Let there be a compelling argument in favor of probability computation that asserts the probability of some event e, to be p(e). A BiPSA operator to which that logic is known, would use it as a BiPSA respondent with compelling priority. The input of that logic would be the value b(e) according to S. However, the said priority would guide the integration to agree with that value, practically ignoring any contradictory responses. So the outcome of the BiPSA process would be b(e), which would then be translated back to probability rating, according to the same arbitrary scale S, and yield p(e). In summary, the BiPSA process was in that case superfluous, but not corrupting in any way the probability calculus.

For example: a BiPSA statement asserts that in the next roll of a dice, it will show the number “3”. Probability calculus will assert that event to happen at probability p=⅙. Some human sources may respond based on different knowledge. One might not realize that a dice has six faces, and theorize that all the numbers 0-9 are possible. Another might have a mystical belief in number “3” and be sure that it would pop up. A judicial BiPSA operator would minimize the impact of the last two, and allow the calculated probability to sail through. However, that particular dice might have been tampered with, and a fourth source would extract this fact by carefully studying the past performance of that dice, arriving at a more accurate conclusion than the calculated probability which was tacitly based on the assumption that the dice is fair. Even, if the BiPSA operator does not immediately acknowledge that edge held by the fourth source, the actual BiPSA process, replaying similar questions for repeated dicing, would increase the impact of that BiPSA source through the BiPSA feedback procedure. And so eventually the outcome of the BiPSA integration would differ from the answer given by the probability calculator, and in that case the exact definition of S would be consequential.

In simple terms, one could ask. Given an event associated with a BiPSA rating of b, what are the chances for the event to happen, or alternatively: what is the probability of that event?

Let p be the answer. In that case we have a mapping of b−p. Today, if an elaborate BiPSA procedure would conclude an event to be associated with b BiPSA rating, the user would immediately turn around and ask: “What is the corresponding p value?” And that is because we are all used and trained to think probabilities, and not BiPSA. It is like when a European visits the United States, he translates the weather reports from Fahrenheit to Celsius so he knows whether to take a coat in the morning. But after living in the US for a while, such translation will be superfluous, the visitor will start thinking in Fahrenheit. Same here, there is no reason that after some getting used to, people will be happy to quote the BiPSA rating of an event without needing to convert that rating to a probability percentile.

When mapping BiPSA rating to probability values we may rely on three ‘hooks’ based on the definition of the two terms:
i. b=−N corresponds to p=0
ii. b=0 corresponds to p=0.5
iii. b=N corresponds to p=1.0

Further more we must logically obey the monotony relationship expressed above: if b rises, so does p; if p rises, b cannot decrease.

We shall now use these ‘hooks’ to define Nominal (linear) BiPSA-probability mapping:

This mapping complies

$$p ( b ) = \frac{N + b}{2 N}$$

with the three ‘hooks’, and the monotony requirement.

Based on this mapping any BiPSA source that answers a BiPSA question with probability rating may have its answer translated into BiPSA, and any integrated BiPSA result may be readily translated to a probability measure.

This nominal (linear) mapping could have been generalized through an ‘adjustment factor’ (α):

$$p ( b ) = α ( b ) \frac{N + b}{2 N}$$

Alas, the nature of BiPSA dictates: p(b)=1−p(−b) and hence α(b)=−α(−b), which algebraically necessitates: α(b)=1. Therefore the probability adjustment will be chosen as an addition:

$$p ( b ) = \frac{N + b}{2 N} + β ( b )$$

where β3(b)=−β(−b).

[image]

This arrangement introduces N degrees of freedom to the algebraic system. Accordingly to fully match BiPSA with probability one would need N conditions. Such can be readily established via event combinations. Let e and e′ be two independent events. One could BiPSA-ask about the occurrence of each, plus inquire about the occurrence of both, yielding: b(e), b(e′), b(e∩e′), with corresponding probabilities: p(e), p(e′) and p(e∩e′). Probability calculus dictates:

p(e∩e′)=p(e)*p(e′) which will serve as a condition to resolve the beta values. One could BiPSA inquire about the eventuality of one and not the other, and any other combination. N such cases would be sufficient to fully resolve the beta values.

If one tests more than N cases, then one might reach a state of no solution for the beta values. This is a case of inconsistency that is to be resolved by revoking the least trustworthy piece of data, as elaborated on ahead.

Note: mapping probability to BiPSA rating produces non-integers, which should be rounded to the closest whole number.

Human Sourcing

Any human issue involved with a measure of uncertainty can be a subject for the BiPSA technique. The general justification for applying BiPSA in human sourcing instances is best captured by the maxim:

No one, however brilliant, would match, for the long run, the wisdom of the relevant community.

BiPSA brings to bear the wisdom of the community at large because it invites all sources of knowledge and wisdom to contribute their share, resolving their differences and do so at the end point before the decision must be given. This insures that no opinion is suppressed at lower inferential echelons; all sources of wisdom get to plead before the ultimate “judge”.

Below we survey some categories of human sourcing, and discuss some general techniques for the same.

Some cases:

.Human Sourcing Categories Categories:

management
research and development
intelligence work
economical analysis and planning
medical treatment
social issues
   .Management

We refer here to management that qualifies as a process where one or few individuals make decisions concerning and activating many more. Decisions involving fate and response of human being are always clouded with uncertainty, and a manager is an estimator of what's to come. BiPSA is very handy, and very useful.

Managers are faced with hard-nose decisions, as well as soft conduct. They need to set specific goal, allocated resources, determine procedures, etc. But they also need to boost morale, enhance team spirit, and inspire loyalty and commitment. BiPSA should help with both.

BiPSA offers the potential of management by inclusion, inviting the many to join in the decision making process. It is empowering and developing a sense of team. Yet, such inclusion does not imply one-man-one-vote, to the contrary, BiPSA offers very tailored discrimination, allotting to each voter the most appropriate impact in the mix.

We discuss below some special cases:
general management
Project management
emergency management
Team BiPSA Management
personal management
   .General Management

BiPSA provides for a sliding shift in the responsibility load from the titular manager to his managed team. We can view an organization as run in two extreme fashions: command and consensus. In the first way, a single general manager makes all the decisions. In the second way, decisions are made by a majority of opinions. Volumes have been written to argue the relative benefits and disadvantages of both systems. What BiPSA does, if offer a continuum between these two extremes, with an easy “sliding mechanism” between them to adjust to circumstances and challenges.

With BiPSA everyone is invited to vote, but the impact of each vote is determined by the BiPSA network. The network itself may be BiPSA determined.

BiPSA offers a separation between the votes, and the way they are integrated. The latter is determined first. The integration network can be displayed in a very readable fashion so that one can appreciate the way votes are accounted for.

BiPSA helps with clarity, helping one define his challenges as a series of binary decisions. BiPSA allows for the opinions of all concerned to be readily integrated and thereby make good on the underlying premise that claims that for the long run, even the brightest among us are no match for the integrated wisdom of the relevant community. The fact that all stakeholders are being consulted is very important in terms of morale, commitment, and loyalty.

Some specific challenges that can be “BiPSized” (BiPSA processed) are:

Executive tasks:
prioritizing goals
selecting strategy

operational tasks:
estimating resources
selecting plan of action
tactical decisions

handling the unexpected:
responding to surprises
watching for fast rising risks

.EXECUTIVE TASKS: BiPSA can help with prioritizing goals, and selecting strategy. The group manager would ask for his people to propose a list of corporate or organizational goals. These goals would be BiPSA prioritized. Similarly the group manager would ask his team to develop several strategic options to satisfy the array of prioritized goals, and those strategies may be BiPSA ranked to select the top strategy.

OPERATIONAL TASKS: These typically include resource estimation, detailed planning, and tactical decisions.

Resource estimation is discussed in project management. Detailed planning can be accomplished by devising several alternate plans, and then BiPSA ranking them. Similar selection for tactical decision.

These ranking procedures would be carried out through multivariate voting, where the manager or the team would decide on how to account for the relative impact of the various management factors.

.HANDLING THE UNEXPECTED: These tasks include a fitting response to a surprise occurrence, and an early detection of a sudden surprise.

.RESPONDING TO A SURPRISE: Management is often judged by its response to unexpected crisis, or to a surprise opportunity. This may challenge management to part ways with linear thinking, ignore inertia, and think afresh. The top manager may have the right idea, but often he or she are concerned that their vision is way ahead of their flock; their strategic view, is not shared by their cohorts and underlings. Memoirs are full of examples where managers pare down their bold vision, afraid that its full impact can not be sold.

BiPSA helps by offering the manager the opportunity to allow his cohorts and underlings to vote on several proposals to meet and respond to the unexpected circumstances. Since the vote is binary, there is no excuse for the voters to back off, should the risky gamble fail. Also, by prompting people to vote the manager calls upon his people to think hard about the situation, and all that thinking is likely to produce some out of the box ideas. The BiPSA vote on a response plan would also allow the manager to realize who believes in his plan, and who doubts it. This knowledge might guide him or her to populate his critical teams with believers-only.

.EARLY DETECTION OF A SUDDEN SURPRISE: In hindsight most sudden surprises have announced their coming via some hard to detect tell-tale signs. The objective of a prudent manager is to be alert to a coming tsunami by reading its faint harbingers. This can be done the BiPSA way by posing one or more “outrageous” scenarios to a large as possible community of BiPSA respondents. Most respondents would likely vote “−N”, but one or few would vote, say “−(N−1)” or even “−(N−2)”. When the same scenario is presented periodically one would track these less-than-perfect-no answers by computing the momentum of each BiPSA answer. If the momentum shows some signs of coming down then, even if the BiPSA result is still a resounding “−N” it should attract managerial attention. Especially of the second derivative of the momentum with respect to time is positive and in a meaningful way.

The manager might present several “outrageous” scenarios for follow-up.

.THE BiPSA RESPONSE TEAM: For general management tasks one should consider a broad base of BiPSA voters. It is important to remember that BiPSA encourages a large variety of opinions to sort them out. Opinions may come with very little impact, or with very high impact, as the case may be. And every opinion given has a chance to be validated or invalidated in the future thereby allowing one to adjust the impact of each voter on account of his or her past performance of relevance.

The reasonable categories of BiPSA respondents are:
1. The executive echelon
2. The tactical managers
3. The line people
4. The support groups
5. People of adjacent departments
6. retirees
7. consultants

.PROJECT MANAGEMENT: Most of the activities of a project manager are those of general management described above, namely: goal setting, strategy picking, surprise readiness, etc. The additional unique duty of a project manager is to come up with a credible estimate of cost-to-complete and time-to-finish.

Such estimates is where the historic roots of BiPSA are found. We generalize now to meet the challenge of project resource estimates.

.PROJECT RESOURCE ESTIMATION: Let R be a resource needed by a project to be completed as planned. The question is how much of R is needed? R may be money, time, human resources, rental hours of some service, etc.

The scientific way to express an estimate is through its probability curve drawn on a plane with the horizontal axis indicating the quantity of resource R needed to complete the project, and the vertical axis indicating probability, so that the curve f(R) would be such that for any two amounts R₁ and R₂ (R₂>R₁) as estimates for the needed quantity of R, the probability for the true value RO to be in that interval, namely:

R₁≦R₀≦R₂

is given by:

P(1−2)=∫f(R)dR from R₁ to R₂

This probability curve is a favorite of theoreticians, and a frequent joke for practitioners, since f(R) is hard to come by.

We have shown before how to use BiPSA to determine a curve. By applying that procedure for the case in point one would generate the traditional probability curve from one or more BiPSA rounds.

.BiPSA Supported Emergency Management:

Emergency, by its very nature, requires swift and well considered response. There is usually not enough time to evaluate all the facets of an emergency and develop an optimal response. Managers rely on ‘gut feeling’ immediate experience and a few trusted aids. Yet, a response often must be judged by factors of which the manager and his aids have no expertise, nor do they have the time to sit and discuss the situation with all those complementary experts. The BiPSA solution to this challenge is as follows:

Let the manager and his closed team develop solution proposals, each with a well defined goal. The team would then phrase a scenario to say that this solution path would achieve its stated goal—asking a large as desired team to BiPSA vote on this proposition. The votes would be integrated using the multi-factored decision procedure and the manager would have in a short time the integrated opinion of all the relevant experts—guiding him for wise action.

This solution is especially important on account of the tendency of many experts to opt for ‘on one hand this, and on the other hand that’. The BiPSA with its binary power forces the experts to speak clearly and unequivocally.

The emergency response team should be trained ahead of time. This training with virtual emergency scenarios are good for all. The challenge here is to find as many experts in a timely manner, and to communicate to them the situation and the proposed solution. This might need special tracking devices, and even encryption so that sensitive situations can be safely communicated back and forth.

.Personal Management

These are applications to be used by individuals for personal management.
Personal Decision Making
Judgment Improvement

.PERSONAL DECISION MAING: An individual finds himself vis-à-vis a critical decision to be made. Perhaps a change of jobs, going to live abroad, marrying or divorcing, etc. That person allocates some weeks for her to think about it. She could use BiPSA in the following way:

First she would phrase the decision as a binary question. She would then answer that question every day afresh. After a set time she would BiPSize the results to find her overall decision.

.Judgment Improvement

A person finds himself making recurrent decisions regarding a similar issue. Sometimes his decisions prove themselves right, and some times they turn out wrong. That person suspects a bunch of factors that affects his decision process. Such are emotional situations, concerns, fear etc. He wishes to make use of this theory and modify his decision based on the values of these parameters.

This can be done in the following way:
1. identify the judgment influencing parameters.
2. build a set of BiPSA matrices to reflect the suspected power play of these factors.
3. Each time such a judgment is being made (phrase the case as a binary call), register the values of the influencing parameters.
4. After several rounds of judgment calls coming back with reality check (feedback), find an adjustment to the original matrix.
   Team BiPSA Management

We consider a team of individuals gathered together for a joint purpose. Necessarily each team member brings to the team different strengths, while burdening it with different weaknesses. Typically team members vie for control and primacy so that the team would behave the way they like it. But an enlightened team might agree that for each member it would be best to suppress his own ego for the benefit of the team as a whole.

We present here a BiPSA procedure that would use the BiPSA primitives of multi-variate voting, and BiPSA ranking to build a management structure that would be more beneficial to the team than the common fixed-role solution.

.THE SETTING: We consider a case where a group of individuals come together with shared goal, and resolve to team up with an effort to achieve that goal.

We shall assume first that the n individuals are equal in their membership and participation. There is no a-priori boss with more rights than the other; no first or secondary ranking—all are equal, and committed to their shared goal. (We shall qualify this assumption later).

Now, no two individuals are alike in terms of their skills, their capabilities, and their weaknesses. Among them someone is better at executive role, someone at technical role, someone at promotion, and other special skills needed to achieve their goals. Recognizing that inequality of skill and attributes, the team as whole decides to use BiPSA to elect the best person to lead in each aspect that requires action and leadership.

2. Team Work: The team will:

1. List work aspects that need leadership: overall, technical, legal, promotional, etc.
2. The team would exercise the BiPSA ranking procedure to rank the members for merit on all aspects identified in (1).
3. Based on the results of (2) the team would nominate leaders in all the listed aspect in (1).
4. The team would agree on an integration matrix to resolve each type of issue, or decision that may be expected in the foreseeable future.
5. As issues arise, the team would express them as a cascade of binary questions and vote on them based on the integration matrices agreed upon in (4).
6. Dismantling: when the team decides to terminate their association (whether their goal was achieved or not) then the team would divide all outstanding assets and liabilities according to BiPSA pie-slicing procedure.

Steps (1-4) above may be repeated from scratch every set period. So, for instance, the team might decide that once a year they would redefine the aspects of interest, and re-rate themselves based on the accumulating experience so far.

1. ASPECT LISTING: Every organization has at least one aspect of interest: general management. The rest are specific to each organization. Business organizations would typically have: marketing, legal, human resources, financial, public relations, promotion, technical, and information technology.

.THE BiPSA RANKING PROCEDURE: In this case the BiPSA voting set is the same as the ranked set, which may suggest a slight modification: no one would vote on his own binary question vis-à-vis another member of the team. This is optional, the team might decide to let members rate themselves vis-à-vis others on every aspect under consideration.

The team could also decide to bring in a trusted advisor to participate in the votes. In that case they would have to agree on an integration network. Otherwise the network gives each team member the same voting weight.

NOMINATING LEADERS: In the ideal case the nomination is straight forward, for each aspect nominate the top ranked individual. What happens often though is that the same individual is voted top in two or more aspects. The team may decide that this gifted individual would wear the two hats. But it may be decided that it's too much work, and both aspects would suffer and so this double top ranked individual would have to be assigned one leadership spot only. That choice may be made with reference to the second ranked individual in each aspect. If in the first aspect the second ranked individual is very closely ranked to the top one, then he or she might serve as leader of that aspect with similar qualities. And if the second aspect has as second ranked individual one who is ranked considerably lower than the top rank, then the double assigned top ranked individual would assume that second post.

.Setting Integration Matrix

The team should list the types of expected decisions, and for each such decision define an integration network that will determine the relative impact of each team aspect on the final decision.

Such a network can be determined per case and with any complexity or desired logic. One could also apply the standard form as follows:

For each decision type the team would rank order the team aspects defined in step (1) of this procedure. This ranking will determine an integration vector (a single column matrix) that would integrate the aspect votes to the grand summary of that decision.

The aspect votes are determined from the qualifications of each team member based on his or her rank for that aspect. These ranking grades will be used as the impact factor for each team member's vote.

Hence, if a given team member was ranked as 7+a (a an arbitrary selection a=0,1,2, . . . ), for a given aspect then his vote will have the (7+a) impact in that aspect summary.

ILLUSTRATION: A small company needs to decide whether to accept an investor offer to pour some money into the company in exchange of equity. The CEO decides that the factors for the decision would be general management, marketing, and technology in that order. So if general management votes “g”, marketing votes “m”, and technology “t” then the final result on whether to accept the offer would be computed from the extended BiPSA:

[final decision]=BiPSA[g,m,t][3,2,1]

The six partners: P1, P2, P3, . . . P6 are ranked per their management, marketing and technology qualifications as follows:

| Partner # | g-rank | m-rank | t-rank |
|---|---|---|---|
| 1 | H | M | M |
| 2 | H | L | H |
| 3 | M | H | L |
| 4 | L | H | M |
| 5 | 0 | 0 | H |
| 6 | 0 | L | H |

The six partners vote (by order): 1,−2,3,−1,−4,1

Accordingly the g-vote is evaluated to be:

[g-vote]=BiPSA[1,−2,3,−1,−4,1][3,3,2,1,0,0]=1

High, Medium, and Low qualifications (H,M.L) are interpreted as: 3,2,1 respectively.

And similarly the m-vote:

[m-vote]=BiPSA[1,−2,3,−1,−4,1][2,1,3,3,0,1]=1

And in the same fashion the t-vote:

[t-vote]=BiPSA[1,−2,3,−1,−4,1][2,3,1,2,3,3]=−1

And hence the final vote:

[final decision]=BiPSA[1,1,−1][3,2,1]=1

And the offer is accepted.

BiPSA ISSUES: Because BiPSA is an effort and an overhead, it is necessary for the

BiPSA decision to be worthy of that effort. This would limit the decision to strategic grade.

Some typical decisions are:
1. redividing the organizational equity and liabilities.
2. allocating voting rights to additional team members.

.VOTING RIGHTS FOR NEWCOMERS: The team may limit the voting board to the original members and deny that right from newcomers. Alas, this policy will deny the team the benefit of the added manpower, and will harm the larger team morale. New comers maybe handled in two ways:
1. team-level voting rights.
2. hierarchy based voting

Any combination will do. So, for example, one or two of the newcomers may be offered a par position of original team impact, while the rest would be voting through a hierarchical regimen.

.TEAM LEVEL VOTING RIGHTS: One simple way to accommodate newcomers is to add them to the team voting routine as if they were the original team members. Alternatively one could group all recent newcomers into a anew combers group g₁, as opposed to the original team g₀. Both groups will respond to the issue at hand, and produce a group summary answer. These two answers would then be BiPSized to generate the summary answer. This last step could favor the original team over the newcomers. Say running an extended BiPSA in the form:

[extended team summary vote:] [B(g0), B(g1); 4, 3]

.HIERARCHY BASED VOTING: Newcomers may be incorporated in a hierarchical structure and hence be organized in sub-teams. When a team worthy issue is coming down the pike, the team might wish to derive from it one or more BiPSA questions to be submitted to one or more of those sub-teams. The BiPSA results of these sub teams will then become data and factors that would guide the team in their voting on the original issue. That way the primacy of the original team is maintained, while the newcomers have a say too. Also, subsequent joiners might have specific expertise which will qualify them to be the primary voter on an issue. Yet, the final vote will be in the hands of the original group.

Research and Development the BiPSA Way

We describe the application of BiPSA for R&D on the basis of the Innovation Turing Machine.

Parts:
1. goal and strategy setting
2. IC appraisal
3. breakdown
4. extension
5. abstraction
   .Goal and Strategy Setting

There is no difference between goal and strategy setting for a nominal project vs. the same for innovation projects, only that the latter calls for more frequent review of the same. The procedures described in the general management sections apply.

.IC Appraisal

The unique feature of appraising innovation challenges (IC) is its doability, feasibility, and the credibility of the estimate for cost-to-complete and time-to-finish.

Doability and feasibility are binary questions that should be BiPSA processed utilizing all available BiPSA sources.

Credibility of estimates is measured according to the precepts of the universal theory of innovation, as presented below.

Estimates of cost-to-complete and time-to-finish, are conducted in the same manner as for nominal projects, only more frequently.

.Credibility Assessment of Innovation Projects Estimates

Credibility, according to the universal theory of innovation is measured by the shape of the estimate probability curve. This curve can be approximated through a BiPSA cascade, as described elsewhere.

Alternatively one could use the BiPSA data in a direct manner as described below.

1. BiPSA Direct Measure of Estimate's Credibility

Let x be the estimated variable, xo be the true value, hunted by the various estimates: x₁, x₂, x₃, . . . xₙ

Let us run BiPSA rounds regarding the following scenario: “The value of xo is higher than a threshold value xₜ”

Let x_{L}(M) be the highest threshold value of x for which the integrated BiPSA result is +M where (0≦M≦N).

Let x_{H}(M) be the lowest threshold value of x for which the integrated BiPSA result is −M

The gap (x_{H-x}_{L})_{M} measures the amount of M-level uncertainty in the estimate according to the participating BiPSA voters, and their integration network. The larger that gap, the greater the uncertainty in the system, measured at confidence level |M|.

It is helpful to follow on innovation progress by tracking its shrinking uncertainty over time. Hence we define project estimate credibility Ω as follows:

$${Ω}_{M} ( t ) = 1 - \frac{{x}_{H , M} ( t ) - {x}_{L , M} ( t )}{{x}_{H , M} ( 0 ) - {x}_{L , M} ( 0 )}$$

When the project is first estimated its credibility is rated as baseline, zero. As the project progresses, its credibility rises up to its maximum level:

0≦Ω_{M}≦1

Ω_{N} is called the ultimate credibility, and Ω₁ is called the high-risk credibility. One should work with the ultimate credibility for high-stake projects, and with lower credibility metrics (lower M values) for less risky projects.

By definition of the incremental momentum, that momentum at point L towards M−1 is 1, and at point H, towards −(M−1) is also 1.

The various credibility metrics may be integrated to form the integrated credibility metric (ICr).

Integrated Credibility

We define for every time point, t, the Integrated Uncertainty, U:

U(t)=Σ_{M}(x_{H,M}(t)−x_{L,M}(t)) for M=1, 2, . . . N

And accordingly, the integrated credibility at time t, IntCr will be:

$$IntCr = 1 - \frac{U ( t )}{U ( 0 )}$$

ranging from zero at the beginning of the project to 1 at its end.
.Breakdown

All three modes:
serial breakdown
parallel breakdown
concentric breakdown
   are treated the way a regular hierarchy is treated.
   Extension

Using BiPSA in conjunction with the extension route is the most difficult application of the method.

We develop the methodology step-wise. Suppose that only one other IC was found to have some similarity with the original IC, and that one is fully resolved. In that case we imagine a BiPSA “dwarf” with that ‘other IC’ knowledge, and for any binary question regarding the original IC, the dwarf answers according to the experience of the other IC. The answer of the dwarf can be positive, negative, positive zero, and negative zero. Among these four answers, the only noncontributing answer is the last. So if the BiPSA operator composes a series of questions for which the dwarf answers with a negative zero, then this extension step is useless. Thus, if the original challenge is some software development and the other IC is a design of an extraction column, then a question regarding the number of lines of codes, will be answered by a minus zero.

If the other IC is not fully resolved then its answer would come with a lesser measure of confidence.

Now, if we have assembled several ICs with some similarity then each IC would be represented by a BiPSA dwarf, and answer per its own data. This would pose the innovator with the challenge of networking these different answers. This should be done on the basis of a metric of similarity between each such IC and the original IC. The distance values will serve as an impact ordinal to effect an extended BiPSA with the values of the various similar IC.

.Measuring IC Similarity

To measure the distance between two ICs one would generate a list of IC attributes with values that have a binary range or bigger, following the BiPSA distance procedure described elsewhere.

Abstraction

When an IC is abstracted, it may be evaluated by a larger circle of BiPSA voters. This is because:
1. some knowledgeable voters who would not delve into the many details of the original IC, might tackle its short form when abstracted.
2. some knowledgeable voters who don't have a clearance to see the confidential details will be able to tackle the IC in its sanitized abstracted form.
3. some knowledgeable voters who may not be familiar with the details of the original IC might come to think about it in its abstracted form.

By enlarging the circle of BiPSA voters, the innovator may harvest more wisdom for his purpose.

BiPSA Intelligence Analysis

It is the nature of intelligence work that someone checks the “elephant's trunk” and another the “elephant ears”, and so on, and subsequently an analyst must deduce that this is an elephant. In practical terms the raw information that should feed into a binary conclusion is extremely multi-faceted, and highly contradictory. This is the classical BiPSA challenge. A judicious application of MFD will be very helpful.

Planning, Analysis, Forecasting

Prior to project management one is usually engaged in forecasting what's to come, analyzing the results, and planning accordingly. Typically projects operate in an economic climate. One needs to precede such management with economic forecasting and analysis.

Economics is a matter of hard-nosed resource availability, and soft issues of human psychology. The combination reeks with uncertainty galore, and BiPSA naturally comes to the fore.

Since economic events are a summary of the individual decisions of many members of society, it stands to reason that these events can best be forecast by polling a sample of the same population, which BiPSA is well designed for. What is needed is a mechanism to reach out to a large pool of BiPSA respondents.

While forecasting is a matter of large pool of respondents, economic planning is a matter of a small group of experts that cover all the relevant fields of expertise. The latter can be carried out using the technique mentioned above for project management.

.Forecasting

Issues that require management tend to require intuitive forecasting. This term refers to forecasting cases where there is no clear formula, no undisputed science, no widely acceptable logic. Different experts of equal credentials may offer squarely contradictory assessment, and each uses a mountain of logic, evidence and erudition. This type of forecasting occurs frequently: when will be get the next recession? When will we run out of oil? When will climate change increase the ocean level by 5 inches? And so on, for global issues. Medical prognosis, what's the weather supposed to be next weekend, are some more pedestrian questions. Such cases are usually handled in a soft way; namely: experts write opinion letters and memorandum, using double-speak to protect themselves against any embarrassing eventuality. Quantitatively one would solicit a number from each expert, then statistically analyze the results. We shall argue below that this method is deficient, and BiPSA cures that deficiency.

Most experts phrase their forecast in ways that do not readily translate into a fixed figure. Suppose one tries to forecast when unemployment will rise to 6.5%. Queried experts would say something like: “I don't’ think this would happen this year, nor in the next, but beyond that I am not sure”, or: “Within the next three years, you bet!” How does one translate these phrases to a definite time point that would express that expert's opinion? In reality experts are being forced to come up with a figure (to remain relevant in their professional community), but this extra step is subject to a great deal of distortion, and it does not represent the level of comfort that the more general phrase provided. BiPSA says to the expert: “You express your forecast anyway you like.” We shall translate your expression to a BiPSA answer. So one would BiPSA-state that unemployment will reach 6.5% by the end of June, Next year, or earlier. And every expert's opinion, however expressed would be translatable to a BiPSA answer {−N:+N}. And since these answers accurately reflect the experts' opinion their fair and balanced BiPSA integration will represent what the body of experts is really saying.

Medical BiPSA

Medicine is a highly subjective practice, and opinions vary. BiPSA would be able to track qualifications and develop a most credible opinion regarding the best medical step in a given situation.

In today's communication rich world, a medical situation can be vividly presented across the world and various experts can pitch in their opinion. BiPSA can be applied towards both diagnosis, and prognosis.

.BiPSA Social

Consider the two following premises:
(i) No one, however brilliant, for the long run, is a match for the wisdom of the relevant community.
(ii) On special occasions, the community fairs better if it follows the lead of a far-sighted visionary, before it shares his or her vision.

Together these two statements claim that while for the long run the integrated wisdom of the many is best, there are pockets of circumstances where singular individuals are smarter than the community as a whole. The challenge is:
(1) to know when and how to apply (i), and when to apply (ii)
(2) to be able to switch between the two.

BiPSA is a tool that allows a community to slide towards more power to the community as a whole, and slide back to more power to some selected individuals for a given case, and keep sliding back and forth for what is best for the community.

Using the various techniques outlined in the management section above, society could manage its well being.

We discuss below some unique situations:
group BiPSA
jury justice
political elections
   Group BiPSA

We consider the general case where a group of individuals, or organizations come together to service a shared goal. The group might wish to maximize the use of the respective talents and capabilities of each member, while minimizing their weakness and shortcomings. To that end they may decide to forgo the one-member-one-vote paradigm and replace it with a group-determined differentiated voting and decision power. To achieve such differentiation the group might agree on procedures that will use the group to establish priority of members per given issues, and the high-priority members per issue of concern will have a greater impact on the binding decision that would guide the group.

Let X be a characterization of some issues that need group decisions. With respect to X, the group will carry out a BiPSA procedure that would result in rank-ordering its members with respect to their due impact on any X-type decision. The respective BiPSA integration network will reflect that rank-order, and any decision of that type would be determined by that network. A similar network will guide the relative impact of members on decisions of a different character, etc.

If the group is large, the procedure of querying each member on each issue may be impractical. One would then categorize decisions not just by their discipline and relevant knowledge but also on the basis of their appropriateness for large group voting. Obviously crisis situations where decisions must come down in a hurry, a small executive subgroup will have to be defined. Generally tactical issues are for the few, strategic ones for the many, and philosophical moral issues are for everybody in the group. The executive cut can be done per issue per the rank-order list.

[image]

THEORETICAL BACKGROUND FOR GROUP BiPSA: A group, large or small, is commonly united by goals, noble or otherwise. It wishes to achieve these goals as expeditiously as possible. Each goal requires different talents and varying capabilities—we take this as a given. We also assume that the following is widely accepted: for every goal there is a ‘talent gradient’ which is rather sharp at the edge. This means that a few are very able and potent players for that goal, a greater number is a bit less than a genius-scale, and still a greater number are above average, and the rest, the majority, are somewhere on the low side of the scale. This talent gradient is shared by groups and societies large and small. We add a third axiom: for different goals, different people are on top, and different ones, in general, are at the bottom. Thus, if a society or a nation wishes to fight a war, then the best people to do so are not the same folks the nation would need to fight a deadly viral pandemic.

To the above assumptions, or axioms, as we would wish to call them, one would add the fundamental BiPSA maxim that says that for the long run, no individual can best the integrated opinion of the society. The latter principle calls for the group, the society, to raise its voice on any issue of consequence for the society. We have seen how BiPSA can integrate the voice of the members of society into a fair and balanced summary. Furthermore, BiPSA is not a one-man-one-vote procedure, it allows for the more worthy to count more. So BiPSA could take a given talent gradient and use it to judicially integrate the opinions of the members of society. The question remains, who would assign the grades, the marks from which the talent gradient would be established?

This is another societal task. And hence it can be carried out by a top executive or a governing committee—on one hand, or by the population at large, on the other hand. Now since this talent gradient would be very influential in integrating all the decisions of consequence for the society, one would argue that it would be too risky to place this groundwork task at the hand of a top few. They might act to perpetuate their hold on power and never yield to better ones. The few, if allowed to determine “weight” and impact, would be able to neutralize any worthy competition by associating them with low impact voting. By contrast, if the talent gradient would be determined on the basis of one-man-(or woman)-one vote, then society at large will maintain its ultimate authority on its destiny while creating a talent gradient where a few will count for more based on societal determination of merit. And that's the theoretical basis for the BiPSA way for group management.

Political Elections

The power of MFD is not very well received in the political arena, where the sacred principle of one-person-one-vote should be upheld. Albeit, one BiPSA attribute should be well accounted for: zero voting. The BiPSA algorithm counts how many voters have been unable to make the requested binary choice, and voted the two options as equally attractive. The more so, the lower the confidence in the outcome.

Similarly political elections could feature the option of “none of the above” to allow the voting public to register its dissatisfaction with the choices placed before it. An elected official who was elected with a large block of “none of the above” votes will hardly be able to claim a strong mandate from the people. He would only be able to regard himself as the least unattractive candidate. Such a tally might eventually lead to consequences, like a sooner next election.

Jury Justice

The very system of jury trial was an inspiration to the design of the BiPSA concept: wrestling power away from an individual, albeit learned as he may be, and placing it in the hands of twelve peers of the accused.

Today, in BiPSA terms the jurors have only two voting options: −N, and +N, and conviction is rendered only if the BiPSA summary is +N on the ‘did it’ scenario. This situation, unfortunately, invites injustice on its two ends: guilty parties that are able to fog-up the situation extract a cautious “−N” from even a single individual, and get scott free, and on the other hand heinous crimes for which the jury is reluctant to end up with no conviction, get pinned on a guilty looking individual, with all contrary doubts stamped out.

Applying the full range of BiPSA {−N:+N} would open possibilities for better justice. For example: a (N−1) conviction can not fit with capital punishment—no matter how heinous the crime. An (N−2) conviction will be open for retrial consideration, if new evidence emerges. A “−1” acquittal will be open for a new trial (voiding the rule of double jeopardy).

The legal system is very heavy, and radical changes like these are very hard to come by, nonetheless they are mentioned here for the record.

Human Sourcing BiPSA Procedures

Some procedures are prevalent within human sourcing instances. They are discussed below:
1. BiPSA Personal Attribution voting
2. BiPSA ranking
3. BiPSA Hierarchy integration
3. BiPSA Forecasting
3. BiPSA Opinion surveys
   BiPSA Personal Attribution Voting

We first discuss the prevailing voting mechanism, identify a certain deficiency there, and then present the BiPSA way.

.Prevailing Human Voting Mechanisms

Whenever people vote there are two procedures that are generally used:
1. one-man-one-vote
2. shares voting

In the first option all voters have the same impact on the result; in the second each voter's impact is proportional to the amount of shares he or she possesses.

Political voting are an example for the first category, corporate boardroom voting is an example for the second.

In other words, we have either zero differentiation between voters, or one-factor differentiation (number of shares). Albeit, in many practical cases one may wish to assign impact to voters on the basis of a combination of factors. Case in point: People vote on the desirability of rescue plan for hostages trapped in a chemical factory by a gang of terrorists. One would wish to assign a higher impact to a voter who understands hostage takers, has familiarity with the culture that drives the terrorists, and also is familiar with the peculiar risks of the chemical plant. Voters who have familiarity with just few of these aspects should count less. As a matter of logic one would wish to assign different weight patterns to the same voters if they vote on a different terrorism plan where, say, no chemical hazards are present. Such adaptable multi-variate impact is not covered by the prevailing voting mechanism.

BiPSA provides an answer.

Multi-Variate BiPSA Voting

Procedure:

Given a certain issue for which people are asked to vote, do:
1. develop a list of impact factors.
2. rank the list in (1).
3. assemble a group of BiPSA voters.
4. identify the association of each member in (3) with each factor in (1).
5. build a BiPSA matrix based on (4)
6. let the people in (3) to BiPSA-vote on the issue of interest.
7. integrate the votes in (6) according to the BiPSA matrix in (5).
   .Develop and Rank Impact Factors

Human voting impact factors may generally (but not necessarily) be categorized as:
1. knowledge/education of relevance
2. functional position of relevance

Each category may be further defined. The knowledge/education category may be broken down to several fields of relevant knowledge. For instance, if the voted options are alternatives of medical treatments, then relevant medical education is a logical impact factor. A voter who is a doctor should count more than a voter who is a lawyer. The functional position category would also be open to further definition, say: current office holders vs. “has beens”. Position of top management, middle management, non managerial personnel, consultants (internal, external), etc.

Once the individual factors are identified they are ranked by defining their BiPSA matrices, or by drawing their BiPSA network. That matrix can be defined using the BiPSA human voting procedure.

For example, one wishes to BiPSA-vote on candidates for their inclusion in some project team. The impact factors are identified as follows:
Position, P
executive, E
middle management, M
consultant, C
Expertise, X
project technology, T
underlying scientific discipline, S

Using network terminology the BiPSA network might look like this:
Position Vote, VP=[VE, VM, VC; E=3, M=2; C=1]
Expertise Vote, VX=[VT, VS; T=3, S=1]
Summary Vote=[VP, VX; 2, 1]

Where VE, VM, VC are the summary votes from E, M and C respectively; VT, VS are the summary votes from T and S respectively. VX and VP are the votes of X and P respectively. These summary votes will be processed from the raw votes of the voters multiplied by their factor qualification matrix, as discussed ahead. In matrix notation: VC F

The vector V={VE, VM, VC, VT, VS} is multiplied by the first matrix, Bf:

[image]

$$Bf = \begin{matrix}\vert 3 \; 0 \vert \\ \vert 2 \; 0 \vert \\ \vert 1 \; 0 \vert \\ \vert 0 \; 3 \vert \\ \vert 0 \; 1 \vert\end{matrix}$$

And the resultant vector is multiplied by the categories matrix, Bc:

$$Bc = \begin{matrix}\begin{matrix}\vert 2 \vert \\ \vert \vert\end{matrix} \\ \vert 1 \vert\end{matrix}$$

So that the summary BiPSA vote is given by: V*Bf*Bc

PREPARE A VOTING TEAM: Once the options to be voted on, and their factors were identified, one would then assemble a team of voters, and qualify them with the identified factors.

The factor qualification is important to reflect the objective for those who have the relevant experience and knowledge to have a greater impact. But, on the other hand, it is a mechanism for inclusion, inviting people “further from the center” to chime in their opinion, and exert their influence on the result. Over time the impact of each individual may be increased or decreased according to some recent evaluation. Even if a distant voter is associated with virtually zero influence, still the BiPSA participation would put that voter on record, and if subsequence reality checks would validate his opinion then his impact will rise.

The association of each BiPSA voter with any impact factor may be carried out ordinally by allowing a field of four levels:
negligible: 0
low level: 1
Medium level: 2
High level: 3

Which, at will, could be refined as follows:
negligible: 0
low level: 1
moderate level: 2
substantial level: 3
High level: 4
top rank: 5

Each voter then would be associated with a tuple (vector) that would reflect his “grade” with respect to every impact factor.

So, for example, if the case is associated with 4 impact factors: f1, f2, f3, and f4, then some voter x would be associated with a tuple:

x: H−0−L−M

Meaning: voter X qualifies as “high” for impact factor fl, has not merit or claims of knowledge or experience as far as f2 is concerned; claims level “low” for f3, and “medium” for impact factor, f4.

In general, i=1,2, . . . n voters in a case with j=1,2, . . . m impact factors will define a qualification matrix, as follows:

$$Q = \begin{matrix}\vert {b}_{11 } {b}_{12} {… b}_{1 n} \vert \\ \vert {b}_{21 } {b}_{22} {… b}_{2 n} \vert \\ \vert … \vert \\ \vert {b}_{n 1} {b}_{n 2} {… b}_{nm} \vert\end{matrix}$$

where bᵢⱼ is the grade of voter i with respect to impact factor j.

.VOTING AND INTEGRATION: Once the qualification matrix has been established, the voting team is ready to vote on any BiPSA issue that is covered by that matrix. Their voting record: v₁, v₂, v₃, . . . vₙ comprises the n-size raw vote vector, v, which is then BiPSA multiplied by the qualification matrix, followed by BiPSA multiplying the result with any subsequent impact factors matrices, leading to a final BiPSA result for each vote.

$$\{ {v}_{1} , {v}_{2} , {v}_{3} … {b}_{1 n} \} * \begin{matrix}\vert {b}_{11} {b}_{12} … {b}_{1 n} \vert \\ \vert {b}_{21} {b}_{22} … {b}_{2 n} \vert \\ \vert … \vert \\ \vert {b}_{n 1} {b}_{n 2} … {b}_{nm} \vert\end{matrix}$$

BiPSA Ranking

The case in point is very common: a given set of n options needs to be rank-ordered, prioritized. We identify two categories:
order-only ranking
scale-order ranking

In the first case only the order of the options matters, in the second the options are to be mapped into a scale so that their relative preference can be quantified.

The first is a case of, say, rank-ordering a team for promotion: who is first, who is next, etc. The second is a case, of, say, n projects need to be budget-allocated according to their relative merit and priority.

We shall resolve the scale-order case, for which the non-scaled option is a private case.

.Scale-Order BiPSA Ranking

Procedure:

Given n options to be scale-ranked, do:
1. Prepare a set of BiPSA voters including their factor-matrix.
2. Run a set of BiPSA ranking questions among the people in (1).
3. Evaluate ranking consistency (compute consistency metrics)
4. Build a BiPSA matrix-set to minimize ranking inconsistency.
5. rank the options according to the matrix set in (4)
   .Prepare a Set of BiPSA Voters Including Their Factors Matrix:

On one hand the group so selected should be as large as possible to reach out to all sources of relevant wisdom. But on the other hand running a large BiPSA group is cumbersome, costly and slow, so in cases of emergency or of limited significance the group of BiPSA respondents would be limited.

In a multi-factored voting scheme one would wish to extend the group until all the relevant factors are properly represented in the group. Beyond that the motivation to increase the number of respondents is getting lower.

.SELF VOTING GROUP: This is a special case where a group of individuals vote to rank themselves. In that case the voted options are the same set as the voters. This case should proceed as usual, only that no individual would be asked to vote on a question that pits him against another. This is because such vote (comparing self to another) would be highly subjective, and contaminate the BiPSA integrated result.

.STANDARD FACTORS FOR RANK ORDERING: When a group of BiPSA respondents is called to rank-order a list of options, they are asked to opine over every couple of options, i and j, and these opinions are then integrated to determine the group conclusion regarding i vs. j. The group members are integrated according to the relevant factors. Some factors may be specific to a certain ranking case, but others are generic and typical of every BiPSA ranking:

Let i and j be two options that need to be BiPSA compared with respect to fitting for a subject, topic, test-case, X. The BiPSA respondents would be distinguished based on their attributes per the following questions:
1. How much do you (the BiPSA voter) know issue X?
2. How much do you know option i?
3. How much do you know option j?
4. With respect to both i and j what are your factual relationships? superior/inferior (now, or in the past), peer, student/teacher, none of the above.
5. With respect to both i and j how much emotional charge do you have: including strong affection, or strong disaffection?

Naturally, positive answers to questions (1,2,3) above would increase that voter's impact, the impact of the relationships is complicated, but a strong positive in (5) would diminish that voter's impact.

.Run a Set of BiPSA Ranking Questions

This step is comprised of setting up several BiPSA sessions. Each session compares two options, A, and B for their relative suitability for the position at hand. Each voter is asked to answer the following three questions:
1. Select the most suitable answer:
1.1: Option A is more important/suitable/desirable than option B.
1.2: Option B is more important/suitable/desirable than option A.
1.3 I am uncomfortable with either of the above two statements.
2. Select the most suitable answer:
2.1 Option A is considerably more important/suitable/desirable than option B.
2.2 Option B is considerably more important/suitable/desirable than option A.
2.3 I am uncomfortable with either of the above two statements.
3. Select the most suitable answer:
1 3.1 Option A is overwhelmingly more important/suitable/desirable than option B
3.2: Option A is moderately more important/suitable/desirable than option B.
3.3 Option B is overwhelmingly more important/suitable/desirable than option A
3.4: Option B is moderately more important/suitable/desirable than option A.
3.5 I am uncomfortable with any of the above four statements.

The 45 possible combinations of results include only 9 combinations which are logically consistent. These combinations can be mapped into an ordinal scale as follows:
1.1, 2.1, 3.1 maps into the ordinal +4
1.1, 2.1, 3.2 maps into the ordinal +3
1.1, 2.3, 3.2 maps into the ordinal +2
1.1, 2.3, 3.5 maps into the ordinal +1
1.3, 2.3, 3.5 maps into the ordinal 0
1.2, 2.3, 3.5 maps into the ordinal −1
1.2, 2.3, 3.4 maps into the ordinal −2
1.2, 2.2, 3.4 maps into the ordinal −3
1.2, 2.2, 3.3 maps into the ordinal −4

As a result any two options A, and, B, among the options to be ranked would be associated with an ordinal preference indicator, I

(A, B)−>I {−4,−3,−2,−1,0,+1,+2,+3,+4}

where positive indicators favor B, and negative ones favor A. These questions can be asked with respect to any pair of options, which is the complete voting array, or any fewer number of pairs, if the complete array is too cumbersome to handle. At the very least a list of n options should be processed through (n−1) comparisons where each option is compared to twice except the first and the last ones (the minimum voting array). Hence if one needs to rank four options: A, B, C, and D, then a full voting array would consist of the following BiPSA questions:
A vs. B
A vs. C
A vs. D
B vs. C
B vs. D
C vs. D

And a minimum array may look like:
A vs. B
B vs. C
C vs. D

As the number of options to vote on, n, is increasing so does the gap between the complete voting array and the minimum option (as far as the number of BiPSA sessions are concerned).

Let there be O₁, O₂, O₃, . . . Oₙ options to be ranked. By running (n−1) BiPSA comparisons: Oᵢ vs. Oᵢ₊₁ for i=1,2, . . . (n−1) (the minimum voting array), one would generally have sufficient information to construct a ranking vector (assign a ranking number to each option). One would simply assign an arbitrary number X to option 1, then set the other ranks by the successive values of the BiPSA results.

Let by [Oᵢ, Oⱼ] where bᵢⱼ={−N: +N} where the positive results indicate preference of option j over option i, be the BiPSA result of comparing option i to option j.

Note: bᵢⱼ represents the result of running the binary preference questions (i vs. j) by the entire group of BiPSA respondents, and having their votes integrated according to the integration matrix constructed on the basis of the relative impact of the factors that are relevant for that selection, and on the basis of the merit indicators of the various voters with respect to these factors.

One would then set:
R₁=X
R₂=X+b₁₂
R₃=X+b₁₂+b₂₃=R₂+b₂₃
. . .
. . .
Rₙ=Rₙ₋₁+b₍ₙ₋₁₎ₙ
   where Rᵢ is the rank of option i

This would work except in the following case, where for some i there would be:

bᵢ₍ᵢ₊₁₎=−b₍ᵢ₋₁₎ᵢ and |bᵢ₍ᵢ₊₁₎|=N

Using the above described assignment procedure one would record:

Rᵢ₋₁=Rᵢ₊₁=Rᵢ+N or: Rᵢ₋₁=Rᵢ₋₁=Rᵢ−N

depending on the case. However, since N is the maximum gap between two options as expressed via BiPSA then the case above does not provide any information about the relative rankings of Rᵢ₋₁ and Rᵢ₊₁.

For case in point let us consider a situation where the ‘true’ relative merit of three candidates (A,B,C) for a certain position are:
A=1; B=8; C=2

Using BiPSA we should get (for the customary N=4):
b_{AB}=4; b_{BC}=−4
which would lead to the following assignment: A=1, B=5, C=1, creating a wrong equality between options A and C.

This case (designated as the extreme opposite case) should be resolved by conducting another BiPSA comparison between options i−1, and i+1. One would then achieve consistency by assigning ranking values according to the ranking inequality of extreme gaps:
Rⱼ−Rᵢ≧bᵢ for bᵢⱼ=N
And
Rⱼ−Rᵢ≦bᵢ for bᵢⱼ=−N

In the example above, one would record: b_{AC}=1; b_{AB}=4; b_{BC}=−4 which would lead to the following set of equations:
R_{B}≧R_{A}+4; (1)
R_{C}=R_{A}+1; (2)
R_{C}≦R_{B}−4 (3)
which are consistent with the known rankings of the candidates.

EVALUATE RANKING CONSISTENCY, AND REPAIR AS NEEDED: Gathering ranking information through BiPSA sessions as described above is subject to distortion based on a strong emotional charge between a particular BiPSA voter, and a particular option to be ranked. This is especially acute when the ranked options are people. One voting individual might have some strong affinity, or the opposite towards some person to be ranked, and that emotional energy clouds one's best judgment.

Such distortion can be spotted and corrected for, if the ranking cycles are larger than the minimum ranking count. If the bilateral BiPSA results rate one option more than once, than it provides information that can be used to evaluate the consistency of the results. The complete voting array challenges and checks the consistency in the most rigorous way, and that is its merit to be counted against the extra labor of running all those many BiPSA sessions.

It is mathematically obvious that the minimum voting array would allow for a perfectly consistent scaled ranking result. Albeit, if more comparisons are being made, then these extra results may harvest some inconsistencies, which would have to be resolved. For an extreme case of inconsistency consider three options to be ranked: A, B, and C, where:
b_{AB}=+K; b_{BC}=+K; b_{AC}=−K

For any K≦N/2 only a value b_{AC}=+2K (3K gap from the recorded one) would insure ranking consistency. For K=N a value of b_{AC}=+K would insure consistency (2K gap from the BiPSA recorded value).

This example also highlights the fact that ranking inconsistency is a result of some illogical (emotional likely) voting considerations.

Resolution to this inconsistency can come from a special ranking resolution matrix (RRM) which would multiply the raw ranking votes.

Application of the RRM requires resolution of a BiPSA equation for which there is no known solution procedure yet. So it may be practical to look for less rigorous alternatives, such as:
1. voter elimination.
2. slack
2. adding voters
2. admonishing and repeating

The procedure of voter elimination calls for eliminating one voter at a time, checking again, if there is such a voter that when eliminated allows the rest of the voters to achieve consistency. If such a voter is found, he or she is eliminated. If more than one is found, then eliminate the one with the smallest impact on the summary result. Formally voter elimination is a special case of the RRM.

Slack is practiced by allowing the ranking equation to slack off into greater degree of freedom:
Rⱼ−Rᵢ=bᵢⱼ+slack_{y}
where the value of slack is flexible, and ranges: at desired minimum: slackᵢⱼ={−1,0,+1}, or in worst case: {−N:+N}. Slack—at the sore price of arbitrary input—offers guaranteed resolution to any apparent inconsistency.

Adding voters is another approach that would generate new summary votes, which might lead to mutually consistent options ranking.

A simple, non mathematical way is to simply explain to the voters that collectively they vote in a way which is not mutually consistent, and then the votes should be cast again. This might help.

Any combination of the above would be helpful too.

.RANKING RESOLUTION MATRIX: For each binary comparison of any two options in a list of n options there are k BiPSA votes, issued by the s members of the BiPSA board. These {vₖ} votes are then multiplied by a matrix, B_{f}, reflecting the impact of the various relevant factors that map the {vₖ} vector to a summary opinion. Suppose we find out that these summary votes engender inconsistency. In that case one may search for a ranking resolution matrix RRM that would multiply the original {vₖ} vector before it multiplies the factors matrix Bf, such that the summary opinions for the relative ranking of the n options would be mutually consistent.

Thus for i,j=1,2, . . . n, and for k=1,2, . . . s, for any BiPSA opinion determining relative ranking of two options, i and j, we have:
bᵢⱼ={vₖ}*RRM*B_{f}

Such that the resultant ranking attributes, {Rn}, are mutually consistent. The above equation is a BiPSA matrix expression.

This is an example of a BiPSA equation to be resolved. In the general case there may not be a solution or there may be several of them. In the latter case one may opt to select the one that generates ranking that keep the options close in its inconsistent ranking as possible.

.Mapping BiPSA Ranking to “Pie Slicing”

Oftentimes BiPSA ranking of options should guide one to slice a finite “pie” of credit/asset or debit/liability, and divide it among the ranked options.

Examples are: (1) parallel breakdown of a parent node to competing components, each with its own likelihood to be the one to succeed. BiPSA could rank order the options, but that ranking should be translated to probability figures. (2) BiPSA ranking of competing projects for a fixed investment fund should guide one to dividing the funds.

In all those cases we have BiPSA ranking that assigns ordinal figures to the various options on the basis of the BiPSA gaps between the options. This ranking can be expressed as:
R(1)=a
R(2)=R(1)+r₁₂
R(3)=R(2)+r₂₃
. . .
R(n)=R(n−1)+r₍ₙ₋₁₎ₙ
   where r₍ᵢ₋₁₎ᵢ is the BiPSA ranking gap between option i and (i−1); R(i) is the ranking figure for option i, and a is an arbitrary figure.

We assume the options are organized in ascending order, so that r₍ᵢ₋₁₎ᵢ will never be negative.

The low arbitrariness assignment of the pie will be:

$${A}_{i} = \frac{a + R ( i )}{\sum {R}_{i} + na}$$

where a runs from 0 to infinity. And when it does so the respective allocation runs in the following range: R(i)/ΣR(i), for a=0 to 1/n for a→∞.

The middle of that range would be a low arbitrariness pick. Hence the allocation portion for claimant (option) i, Aᵢ will be:

$$Note that \sum ( A ( i ) ) = 1 \\ {A}_{i} = \frac{\frac{{R}_{i}}{\sum {R}_{i}} + \frac{1}{n}}{2}$$

.THRESHOLD PIE SLICING: We consider the case where one would envision a practical minimum for an allocated share. By running the pie-slicing procedure above, over a range of n claimants, it may happen that the lowest allocated claimant is below that minimum. In that case one would re-run the same procedure over the top (n−1) claimants, allocating zero to the cut-out member. If again, the lowest allocated claimant is below the threshold, then re-run the procedure without the new lowest option. This should be repeated until such time that the lowest option is allocated a slice of the pie that is equal or higher than the preset threshold.

This threshold pie-slicing procedure is less arbitrary than a-priori deciding to allocate only the top t<n claimants.

For example: Alice, Bob, Carla, and David (A,B,C,D) compete on a given budget. They vote on themselves and establish the following BiPSA values: b_{AB}=+2, b_{BC}=+3, b_{CD}=+4. They decide as a matter of rule to use the shift value a=1, and hence they assign pie-slicing values as follows: A=1, B=3, C=6, D=10. Accordingly the respective shares of the pie would be: A−5%, B−15%, C−30%, D−50%. Each would get its share. However, it as a matter of rule the group has decided on a minimum allocation of 25%, then A does not meet that requirement. According to the procedure above A will be allocated 0%, and the rest would be reassigned pie-slicing values according to the BiPSA results: B=1, C=4, D=8, which leads to the following allocations: A−0%, B−7%, C−31%, D−62%

.Ranking Dishonesty:

The very idea of BiPSA ranking is to place the power of ranking in the hands of the many rather than in the hands of the few, or the one. So BiPSA by its very nature makes it more difficult for a single dishonest source to tilt the results and bias the outcome.

Moreover, one might entertain the conjecture that a single BiPSA respondent bent on biasing the result in favor of a given member of the ranked list will have no sure way to achieve its aim, as long as he or she does not know how the others are going to vote, and there is no cahoots with someone else. This is because to promote a candidate one would have to demote its main competitors, but it's not clear who they are—If the votes are confidential.

BiPSA Hierarchy Integration

Consider a scenario that involves a big multi-faceted plan, that is comprised of many parts that require different fields of expertise. In order to pass judgment on that plan, it is desirable for all relevant experts to BiPSA vote on it. Alas, the plan is so big that a given expert will not have the time and the ability to review all the parts of the plan that are relevant for his expertise. Every expert can review just part of the plan. In fact, such plans are often divided hierarchically into parts and subparts, and each “node” in the hierarchy has different people taking care of it. These node experts can vote intelligently on their node, not on the plan as a whole.

This challenge calls for a special BiPSA procedure: the BiPSA breakdown procedure. Following the breakdown procedure documented in [Samid 06: “The Innovation Turing Machine”] a plan of action, or a challenge expressed by an objective can be broken down to components three ways:
Serial Breakdown
Parallel Breakdown
Concentric Breakdown

Each component may be broken down the same way thereby establishing a hierarchy. Below we shall describe procedures to extend BiPSA integration across hierarchical layers.

BiPSA Hierarchy Procedure—Formal Presentation

A hierarchy is comprised of generic entities known as “nodes” which are organized as “families” where a family is defined as a configuration of nodes wherein a single node designated as “parent” is associated with n=0,1,2,3, . . . “children nodes”. Any child node may be a parent of its own family, and every parent except one known as the “root” is a child in another “higher” family.

To present the BiPSA hierarchy procedure we shall consider the following situation:

Given a family comprised of a single parent, P, and n children C₁, C₂, C₃, . . . Cₙ. Let b(P) be the BiPSA result of some question regarding P, and let b(i) be the BiPSA result of some BiPSA question regarding child i.

Let r₁, r₂, r₃, . . . rₖ be k rules that relate the values of the above mentioned (n+1) BiPSA cases.

We now consider the case where the values of the (n+1) BiPSA cases and the associated k rules exhibit some mutual inconsistency. In order to resolve this inconsistency one would first apply a ranking procedure to the (n+k+1) entities with respect to credibility.

Any rule that ranks below any BiPSA variable that it refers to will be readily ignored. The remaining rules will have to be satisfied.

We distinguish between two cases:

For a given rule
1. there is a single BiPSA variable that is ranked the lowest.
2. two or more BiPSA variables are equally ranked as the lowest.

In case (1) the BiPSA variable ranked the lowest would be adjusted to satisfy the rule. If more variables need to be adjusted to satisfy the rule, then the two options above apply again for the rest of the BiPSA variables. And so on.

In case (2) above the variables sharing the bottom rank would be sorted out using the momentum-based conflict resolution technique. It would point out the variable to be changed, and if its change is not sufficient to satisfy the rule then we have again the two options above.

This procedure would insure that the BiPSA variables that comprise a family are mutually consistent.

To extend this consistency hierarchy-wide one would apply the tree diffusion procedure.

.THE TREE DIFFUSION PROCEDURE: The procedure works as follows: Start with any family in the tree, and apply the above procedure to render it consistent. Move to any other family on the tree, and do the same. Repeat until all the families on the tree are adjusted in turn. This does not complete the BiPSA tree diffusion procedure because when a node was changed in a given family it might violate the consistency in its other family, if any. So this procedure must be repeated until such time that one checks all the families of the tree, and finds them all consistent, and in need of no adjustment.

.Serial Breakdown

In a typical serial breakdown we commonly find three types of rules:
1. attribute summation.
2. node scheduling
3. achievability

We shall discuss each.

ATTRIBUTE SUMMATION: In a typical project hierarchy one breaks down a task to subtasks such that for a typical resource, R, like money, people, supplies etc. one can write:
R_{P}=R₁+R₂+R₃+ . . . Rₙ

This rule is inherent to the breakdown, and hence comes with practically infinite credibility.

For each of the (n+1) nodes one may have a BiPSA result that puts the resource count for that node, i, between a low value Li and a high value Hᵢ. If the BiPSA determined ranges of the (n+1) nodes are such that the summation rule can not be satisfied, then one BiPSA result, at least, will have to be adjusted.

For example: a project X is comprised of two parts, A and B. A BiPSA determination places the cost of X between $800,000 and $1,000,000. The cost of A is BiPSA determined to be between $300,000 and $400,000, and the cost of B is BiPSA appraised as $275,000 and $350,000. The summation rule will insist that the cost of X equals to the cost of A and B. However, it is clear that there are no three cost values for the three entities such that the BiPSA determinations would be satisfied and so would the summation rule. If the cost of B were to be appraised with only extra $50,000 for its high value then, consistency would have been achievable.

.NODE SCHEDULING: If a task is comprised of subtasks, each with its own scheduled starting date and finishing date, then that parent task would have as its starting date the earliest starting date among his children, and as finishing date the latest finishing date among its children. In addition the various sibling subtasks may have mutual constraints. These rules and constraints might clash with the BiPSA determined starting and finishing date.

NODE ACHIEVABILITY: We consider an entity called “parent” (P) which is broken down to n serial components called “children”: C₁, C₂, C₃, . . . Cₙ such that it is necessary to achieve the goal of each and every child for the goal of the parent to be achieved. We further consider a BiPSA scenario that calls for the accomplishment of the stated goal of the parent, or a child, under certain constraints. That scenario may happen or not happen, which is what the BiPSA respondents are called to opine (vote) on. Such a BiPSA setting will be called the success scenario for the respective plan.

We designate the BiPSA result with respect to the parent scenario as b_{P}. We designate the BiPSA result with respect to any child i of P as bi. It is obvious that the achievability of the parent entity cannot be greater than the achievability of the least achievable child:
b_{P}≦MIN{bᵢ, b₂, . . . bₙ}

More precisely, the achievability of P, assuming the children tasks are independent, is given by:
p_{P}=Πpᵢ
expressed in probabilities. Using the above discussed mapping between BiPSA ratings and probabilities, one would write:

$${b}_{p} = \frac{\prod ( N + {b}_{i} )}{{2}^{n - 1} {N}^{n - 1}} - N$$

Thus for a parent with three children with rated BiPSA values of: { 1,2−1}_{N=4} the parent will be BiPSA rated between −2 to −3. And for rating of {1,2,1}_{N=4} the parent will score a BiPSA rating of 0 or −1. If the parent is BiPSA analyzed independently and its BiPSA rating is different than dictated by the above formula, then one would have to apply the inconsistency resolution procedure.

.Parallel Breakdown

When a parent P is broken down to n parallel components C₁, C₂, C₃, . . . Cₙ it implies that any component could be the route to accomplish P. Probability reasoning dictates:

Where p_{P} is the p_{P}=1−Π(1−pᵢ) probability to achieve the parent node, and pᵢ is the probability to achieve child i. The BiPSA ranking can be mapped to probability ratings, and these mapped probabilities will have to match the above condition, otherwise an inconsistency is spotted, and must be dealt with, using one of the methods discussed above. Specifically, we may write:

$${b}_{p} = N - \frac{\prod ( N - {b}_{i} )}{{2}^{n - 1} {N}^{n - 1}}$$

And hence for a parent with three children BiPSA rated as {1,2−1}_{N=4} the consistent parent BiPSA value will be 3, and for {−1,−2−,−3}_{N=4} W the consistent parental BiPSA values are b_{P}=0, or b_{P}=1.

When it comes to resource summary one faces greater flexibility. The relationship to satisfy is:
c(P)=p₁C(1)+p₂C(2)+ . . . pₙC(n)
where c(x) is the cost or resource count for entity x, and pi is the likelihood that option i will end up as the choice to accomplish P.

Since the likelihood figures are malleable, a great deal of seemingly inconsistent resource counts (BiPSA expressed) can satisfy the parallel resource count rule. Albeit, if the n components are BiPSA ranked, then such ranking can be mapped into low arbitrariness likelihood figures. And in that case the ranking itself and the BiPSA cost results will all be thrown into the same pot for momentum based reconciliation.

.Hierarchy Allocation

Consider a hierarchy associated with a “pie” to be sliced and allocated down to its every node. Using the ranking-based pie-slicing procedure one would first agree on a self-cut, 0<z<1.

The parent cut, z, may be the same for each parent or rather specific. It may be determined by the parent, having authority over the children (or by an agent responsible for the parent), or it may be BiPSA determined by some group of voters. Generally the parent allocation could be determined by throwing it into the BiPSA mix, alas, it may result in some awkward allocations where the parent node has nothing allocated to it.

.HIERARCHY ALLOCATION EXAMPLE: An R&D shop has a budget of $2.5 million. It operates in three areas: core technology, support technologies, and ‘blue sky’ ideas. The R&D manager decided to allocate 15% for his management office, and divide the rest among the R&D areas based on running a BiPSA among researchers, marketers, production people, customers etc. The BiPSA runs resulted as follows: “blue sky” (b) was “defeated” by support technologies (s) by a BiPSA value of “+2”. The latter was defeated by core technologies (c) by “+4”, hence, the allocation will proceed as follows:
b=a
s=b+2=a+2
c=s+4=a+6
   where a may be any natural number. For a=1 we have:
b=1; s=3; c=7, accordingly the budget pie would divide:
b=0.09; s=0.27; c=0.64

For a→∞ we have b=s=c=0.33 and hence the low-arbitrariness values are:
b=0.5*(0.09+0.33)=0.21; s=0.5*(0.27+0.33)=0.30; c=0.5*(0.64+0.33)=0.49
   which translates to:
b=0.21*(2.5*0.85)=0.446$MM
s=0.30*(2.5*0.85)=0.640 $MM
c=0.49*(2.5*O.85)=1.04 $MM
   while the parent node will be allocated: 2.5*0.15=0.375 $MM

Now suppose that the core work is comprised of two projects x and y that BiPSA-evaluate into y=x+1. Assuming the same cut of 15%, the projects would be allocated as follows:
x=0.5*(0.5+0.33)=0.415;y=0.5*(0.5+0.67)=0.585

In dollars:
x=0.415*(1.04*0.85)=0.367 $MM; y=0.585*(1.04*0.85)=0.517 $mm

Notice how the BiPSA preference vote translates to hard cash. Without such a vote it would have been quite tedious and ‘unending’ to have every stakeholder, (voter), agree on a dollar cut of the pie. One would argue for a handful of dollars more on this, and some cash less on that. A third would offer a compromise, and on and on. All that has been spared by allowing the voters to express their opinions not dollar-wise but priority-wise. One may note that BiPSA rank-order votes have means to flash out inconsistencies and unbalanced votes so that the dollar result would more closely reflect what is fair and balanced according to the pool of voters, as qualified by their voting matrix.

Forecasting

Forecasting applications may be broadly categorized as:
Extrapolation
Scenario Modeling
Creeping Surprise

The first category is best exemplified in time series. A time dependent variable has a recorded history from which one attempts to extrapolate future behavior. This application is mainly done through computing algorithms and not through human resourcing.

Scenario modeling is forecasting based on constructing a model of the situation and then reading what the model says about the future. The challenge here is imagination and applicability, and it is a classical case where different people develop different models. Creeping surprise is forecasting of a sudden change based on minute telltale signs in the history leading to the manifestation of that surprise.

Most practical cases of forecasting include a mix of the two categories above, and thus using BiPSA one would map the relative impact of data-driven forecast, D, and human-sourced forecasts, H, and define an extended BiPSA like:
[D, H, 2, 3]

To indicate that H result counts more than D, in that particular case.

The H result is to be generated from multivariate voting applications, and in complex cases through hierarchical BiPSA summary.

Of course, it is necessary to define the forecasting question in a strictly binary fashion for the various sources to be integratable.

Alert

It has been said that every big surprise was once an esoteric prediction, nobody paid attention to. One way to be on the alert towards a mushrooming surprise is to follow any rise in its esoteric forewarnings.

A natural way to doing so is to track the BiPSA momentum over time. A BiPSA case may summarize (integrate) to a confident ‘no way’ (e.g −4), and remain so in successive tests. Yet the successive momentum values would decrease from one run to the next, indicating that some consequential sources believe that the esoteric ‘highly unlikely’ scenario per conventional wisdom, is not so unlikely after all.

If the value of

$$- \frac{\partial M}{\partial t}$$

the negative derivate of the momentum over time is growing, then even if the integrated result persists as −4, one should pay attention. And if one observes:

$$\frac{{\partial }^{2} M}{\partial {t}^{2}} \geq 0$$

then it implies that the counter voices, however weak, are accelerating their overall volume, and it may lead to a sudden surprise.
BiPSA Opinion Survey

Every BiPSA run is an opinion survey, but the category here is for cases where the opinion itself is of interest, not its veracity. There is no reality check here. The reason to use BiPSA as opposed to up and down vote count is to be able to analyze the votes based on the factors of interest. So, for instance a survey would show that older people think that Suzy is the most elegant person in the group, and younger ones think that Nancy has a claim to this title. Of course there is no reality check, these are just opinions.

[image]

Non-Human Sourcing

We analyze this topic according to:
Non-human sourcing procedures
Non-human sourcing applications.
   Non-Human Sourcing Procedures

Among the many, we discuss the following:
time series
extrapolation, interpolation
probability analysis
mathematical optimization
multivariate analysis
   Time Series

We envision a situation where a time dependent variable x(t) is recorded at past time points, and that data should serve to predict future behavior.

A BiPSA procedure would be defined as follows:
1. Develop a BiPSA question.
2. Answer the BiPSA question via single data points.
3. Answer the BiPSA question via couples of data points.
4. Answer the BiPSA question via triples to data points.
5. Answer the BiPSA question via 4,5, . . . etc groups of data points.
6. Integrated answers (2-5). [image]
   1. Develop a Time Series BiPSA Question

A typical question would be: at future time point t, the value of x will be within a given range, or above/below a threshold.

For example: tomorrow the value of X will be higher than it is today

The binary question may regard a time interval, and a maxima-minima values therein, as well as many other combinations.

[image]

.Single Point Time-Series

Answer

In this mode we assume that every past point x(past) is the sole source for estimating the future, and hence would set:

x(future)=x(past)

For k past points this procedure would produce k estimates. Each estimate would be translated to a {−N:+N} appraisal of the binary question. If the estimate falls in the middle of the BiPSA range it would be translated to “+N”, if close to its boundaries, but inside, it would be translated to “+1”, and if the same on the other side, it would be translated to “−1”, and if far outside the range, then it would be translated to “−N”.

The above procedure would yield k BiPSA answers to the BiPSA question. These answers would be integrated into the combined answer of the single point mode according to the distance (on the time scale) of every one of the k points to the future time point in the BiPSA question. If the BiPSA question relates to a time interval then the distance would be measured towards the mid point of that interval.

One could use a weight function that is inversely proportional to that distance. Thus if the time series consists of k points (vᵢ,tᵢ) where i=1,2, . . . k, and v indicates value while t indicates time point, and if the BiPSA question is whether the expected value v_{f} at the future point t_{f} will be in a range of high-low (H−L), then the BiPSA vote of each point will be:
bᵢ=(H,L,vᵢ)_{BiPSA Mapping}

And its impact factor, wᵢ, would be:

$${w}_{i} = round {( \frac{λ}{{t}_{i} - {t}_{f}} )}^{2}$$

Where λ is some arbitrary coefficient, ‘round’ refers to a rounding function, and t_{f} is the future time point in the BiPSA question. The BiPSA estimate of this one-point-at-a-time sub-procedure B1 is given by the BiPSA matrix multiplication:
B₁=b*w
Where: b={b₁, b₂, . . . bₖ}, and w=(w₁, w₂, . . . wₖ)
Two Points Time Series Answer

In this mode the k past points are grouped into k(k−1)/2 couples, and each couple projects its estimate towards the desired future time point. This is done by stretching a straight line between the two couple points, and reading where that line intersects the vertical line projecting from the future time point. That value will be translated to a BiPSA answer in the range {−N:+N}, as it was done with the single point case. The k(k−1)/2 answers would stop be BiPSA integrated with their corresponding impact value in proportion to the distance between the midpoint of the couple points, and the reference future time point.

[image]

Three-Points Time Series

Answer

In this mode the K points would be n₃=C³ₖ such groups. Each group would be processed two ways:
1. linear regression.
2. quadratic analysis

In the first way one would draw the best fit straight line among the three points, and project it to the future point, the way it was done with the two points analysis. The second way would fit a quadratic equation to the three points, and project that curve onto the desired future time point.

One would BiPSA integrate the n₃ linear regression estimates, then the n₃ quadratic analysis estimates, and finally integrate the latter two estimates into a single estimate with the two-points, and one-point mode.

[image]

.p-Points Time Series Answer

The k points are grouped into all possible p points, counting
nₚ=Cₖ^{p}
groups. Each group will be associated with (p−1) inference algorithms.
1. single point inference, computing the arithmetic average of the p points, and posting it as the estimate.
2. two-points inference, linear regression line, extending it to the future time point of interest.
3. quadratic regression curve
4. x³ regression curve, x⁴, . . . x^{p}

BiPSA integrating the (p−1) inference models, qualified by the distance between the average spot of the group, and the future time point of inference, and then integrating their results to develop the summary of the nₚ grouping.

.Integrating All the BiPSA Results Above

Following the above procedures one would have k integrated answers for the current binary question. The next step is to integrate these answers. At first these answers could be integrated with equal weight to each, but by experimenting with the data at hand one would modify the final integration and give more impact to the more reliable answer. There are several ways discussed in the literature for dividing k data points to a subset of ‘known’ and a complementary subset of ‘faked unknowns’. One would experiment with several network configurations to get the best result with these subsetting training. Generally moderately changing time series would be integrated with the linear, (two points at a time) answer having the highest impact, while time series that behave erratically would be best configured with higher subsets, say the groups of three points, four points etc.

.Extrapolation, Interpolation

Extrapolation and interpolation will be conducted much like time series. The k data points will be defined as 2^{k} groups where each group is associated with some reasonable inference algorithms, thereby defining the ‘dwarfs’ of the situation. The binary response from these dwarfs is then integrated for the final answer of the binary question. The overall question is broken down, as usual, to a binary cascade, and each binary question is handled separately and sequentially.

.Probability Analysis

In a typical probability calculation one employs probability algebra, working out the probabilities by applying the data at hand. e.g. Bayesian computation. By contrast, the BiPSA way is based on manipulating BiPSA data {−N:+N}. The final output will be in the BiPSA format, which will then be mapped into a probability scale (while this mapping is arbitrary, it should be the same throughout the computation).

For example for N=4 one would map a result r=+4 as, say 95%-100%; r=+3 will be interpreted as 80%-94.9%; r=0 will be viewed as 49%-51%, r=−1 as 40%-48.9%, r=−4 as 0%-5%, or any similar mapping scale. The higher the value of N the greater the refinement of mapping.

Using this mapping one would end up with a probability statement for the binary question in point. Should a given ‘dwarf’ be a probability calculation, it would produce its probability statement about the question in point, but that statement would first be translated to a BiPSA scale {−N:+N} so that it can be BiPSA integrated in the proper network (multifactored perhaps), to produce the final BiPSA result, and only then be translated back into probability. This procedure allows for the power of the BiPSA network to be used anywhere one employs probability calculus.

Mathematical Optimization

In a typical mathematical optimization one seeks a ‘best direction’ in search of some maxima or minima within a multi dimensional metric space. There are numerous optimization techniques all rely on a different cut of the ‘neighborhood information’. Some emphasize slopes, other degree of change of slopes, some view on combination of slopes over two or more dimensions, etc. The BiPSA way is to integrate all these methods into a series of binary questions regarding the bearing of the ‘best next move in search of the maxima or minima’. The various answers are integrated according to a network that builds on its past experience with similar multi dimensional curves.

.Multi-Variate Analysis

Multi-variate analysis appears in a large variety of real life problems. They are traditionally solved via mutli-dimensional algorithms which are intrinsically computationally heavy.

The BiPSA approach is comprised of:
1. Theoretical pre-processor.
2. BiPSA processing.

The theoretical preprocessor will express the body of theory and insight associated with the issue, leaving the residual unknowns to be BiPSA resolved.

We first define the general case of multi-variate problem, then review the theoretical pre-processor, and finally discuss the BiPSA way.

.Defining the Multi-Variate Case

We envision a dependent function Y, suspected to be determined by x independent variables: x₁, x₂, x₃, . . . xₙ
y=y(x₁, x₂, x₃, . . . xₙ)

There is certain insight into the case which leads one write the following function:
y=Z*f(x₁, x₂, x₃, . . . xₙ)
where Z is the ‘fudge factor’, a function of the same n independent variables that takes care of the deviation of f from y. The more accurate one's insight into the issue, the more f is closer to y, and the more z→1, If f provides any insight whatsoever then one would gain accuracy and credibility by solving multi-variate problem:
Z=Z(x₁, x₂, x₃, . . . xₙ)

This problem is completely devoid of theory and insight.

For the classic multi variate case we assume a body of knowledge in the form of k known cases, based on which one tries to estimate the Z value for a new case in point.

We shall use the following notation: the case in point is defined by n values:
x_{0,1}, x_{0,2}, x_{0,3}, . . . x_{0,n}

The knowledge base is defined as:
z_{k′}=z(x_{k′,1}, x_{k′,2}, x_{k′,3}, . . . x_{k′,n})
for k′=1,2 . . . k
.The BiPSA Multi-Variate Solution

The general procedure works as follows:
1. Divide the Z range to two sections.
2. Divide the k cases to two groups: a group with Z in one section, and the rest, the cases where z is in the other section.
3. Divide the range of each independent variable xi into intervals such that for each section the ratio of instances of first group to instances of cases of the second group is as ‘far from 1.0’ as possible.
4. Identify for each xi the interval where the value of xᵢ for the subject case (x_{0,i}) fits. Assign the vote for xᵢ according the above ratio in that interval.
5. Integrate the k votes to a final answer.
6. Check the system (using steps 1-5) with a training set of known cases, and use the feedback to adapt the neural network to improve the results.
   .Illustration

Given five cases, and two independent variables, the knowledge base will look like:

| | | |
|---|---|---|
| No | x1 | x2 |

Group A (z < 1)

| | | |
|---|---|---|
| 1 | 5 | 7 |
| 2 | 4 | 8 |
| 3 | 2 | 4 |

Group B (z > 1)

| | | |
|---|---|---|
| 4 | 2 | 6 |
| 5 | 1 | 5 |

For x1, the range 0-3 has a ratio of 66% in favor of group B. the range 3-5 has a ratio of 100% in favor of group A. If the case in point will have an x1 value of 2.5, then the x1 BiPSA vote will be +3 in favor of group B, and if the value of x1 will be 3.5, then x1 will vote −4 in favor of group B (=+4 in favor of group A).

For x2 the range 0-4 will have the ratio of 100% for group A, and the range 4-6 a ratio of 100% in favor of group B, while the range 7-10 will be marked with a ratio of 100% in favor group A.

For the case in point where x1=2 and x2=5, and a BiPSA question: does that case belong to group B? (yes/no), the individual votes are: v(x1) =+3, and v(x2)=+4 and the combined vote is +4=[+4, +3]

BiPSA Image Processing

BiPSA image processing is based on image information extraction followed by the standard BiPSA inference. Unlike the common approach where image contamination is removed to extract the uncontaminated image for human review, the BiPSA way is to regard the image as a set of opinion sources over a binary question of interest. For example, one would wonder whether an x-ray picture suggests the presence of a malignant tumor (yes/no).

Generally image reconstruction, whether it is noise reduction or distortion removal is based on a host of assumptions which are essentially arbitrary. BiPSA attempts to avoid such assumptions, and simply train its integration network based on known cases.

Images, expressed as a 2D array of pixels lend themselves to human evaluation but pose difficulty to computers. The very same object may be captured twice, even by the same camera, and the per-bit expression of the image will not be identical. Much less so with respect to different devices with different resolutions. Therefore it is necessary first to capture that data in a way that would shake off these differences. This process is referred to as information extraction.

We shall define first the information extraction, then the BiPSA inference procedure.

.Image Information Extraction

The object of this process is to neutralize the natural deviations and discrepancies that show up among different images of the same object, and more challenging: neutralizing the discrepancies that show up among images of different objects of the same category. The process is based on fitting a “grid-tree” over the image, then expressing that image through that grid. That expression should be free of the majority of deviations and discrepancies among images.

Ahead we explain the notion of a grid-tree, and then discuss its ability to express an image.

.The Grid-Tree

A grid-tree in its ‘zero form’ is simply the image as a whole. That image is then divided into n parts so that each element of the image belongs to one and only one part.

Each of the n parts is further divided into n′ parts on average (so now the image is being fitted with n*n′ parts). Each of these n*n′ subparts is may be further divided, and so on, as many times as desired. The final array of image parts may be referred to as children of the part that divided and defined them, and so on, where the the total image (the zero grid) becomes the “absolute parent” for each element.

This is a classic tree definition with any desired number of generations.

There are several ways for dividing an image to such “cells”. The idea is to find a way that would lead to an extraction that would neutralize most of the discrepancies among pictures. Several grid-tree divisions are presented below:

[image]

The ‘Unanchored’ Grid-Tree Method

In this method one would use rectangular division. The total image is viewed as a rectangle, and if it has a different shape one regards the smallest rectangle that envelops that image as the rectangle's image. If the division proceeds with a given division factor n, then both the width and length of the picture are divided to an n×n matrix that covers the entire image. Each of the n² just defined “cells” is again divided to n′² rectangles, and so on, a finer and finer mesh that overlays the original image.

[image]

.Anchored Grid-Tree Methods

This method is based on one or more identifiable points in the image. That point, or points then dictate the method of parceling out the image into parts. The anchor or hook point is identified via a special marker that might be put in place either by the computer that draws the image, or by a human being. Alternatively, the hook will be deduced from the properties of the image itself. For certain applications the hook can be computer generated and marked by a special symbol, on the image. Such is the case for anti-fraud applications.

We discuss single anchor, double-anchor, and triple-anchors.

.The Single-Hook Grid Tree

Given an image marked with a single hook, one would parcel the image using polar element coordinates (rather than the nominal Cartesians). The zero option will be a complete circle (rather than a rectangle as in the Cartesian option). In the first parcelation one would draw n successively smaller concentric rings (all regard the hook as their center), and draw m straight lines projecting from the same hook. The will define n*m cuts of the same image. In the next cut, one would add rings, and add projecting lines to create smaller and smaller polar elements, at will.

[image]

.Double Grid Tree

In this mode the image is anchored in two identifiable spots, and one divides the image area according to magnetic map that would have been drawn, had the two anchor points been magnetic poles.

Triple-Anchor Grid-Tree Method

This method is used if the image is predisposed to three or more anchor points. In that case the grid may take a few competing configurations. Their relative merit depends on the nature of the image, and the nature of the binary question of reference. Example shown

[image]

.Grid-Representation of Image Data

The image covered by the grid of choice is is progressively expressed as follows:

We shall use the term ‘cell’ to describe any well defined part of image based on the grid of choice. The cell will be a “leaf cell” if it does not break down further to sub-cells. Otherwise it would be a parent-cell. For every cell, leaf and parent, and with respect to any two colors (nominally called background, b, and foreground, f) thereto, we define a majority index. The index has a BiPSA format: MI=−N, −(N−1), −(N−2), . . . −2,−1,0,1,2, . . . (N−1), N. Interpreted as follows:
If MI<0 then the cell has more background than foreground
If MI>0 then the cell has more foreground than background
if MI=0 then the foreground and background colors are balanced.

The larger the absolute value of MI the greater the majority of one color over the other. Nominally, the amount of color in a cell is expressed via pixel counting.

This definition is the same for any two colors of choice, but it is clearer to discuss and depict the methodology over black and white images where the background is white and the foreground is black.

In a nominal image, pixilated, this grid representation can be made lossless by reducing the size of the leaf-cell to a single pixel. IN that case the values of MI are: −N, 0, +N. And in the black and white images, the values of MI are further restricted to MI=−N, +N.

For larger leaf cell sizes the grid representation will incur growing information loss, but shorter data files.

[image]

If we take the BiPSA N value to be 4. Then each cell can be grid expressed with three bits: one indicating if MI is positive or negative, the other two are reserved to writing the four BiPSA values: 1,2,3,4. Hence we can write the following table:

| cell size (pixels) | grid-expression (bit size) | % savings |
|---|---|---|
| 1 | 3 | +300 |
| 2 | 3 | +50 |
| 3 | 3 | 0 |
| 10 | 3 | −70 |
| 100 | 3 | −97 |

In other words the majority index allows one to control the degree of data reduction in expressing the image.

For large cells, one may replace a thorough count of pixels with a random pick of pixels inside that cell, and using the fitness ration calculated from the sample to represent the value that is associated with a complete pixel count.

[image]

.The Grid-Tree Cause Differentiation Method

Two images may differ for a variety of reasons, some may be considered ‘normal’ while others are regarded as ‘abnormal’. We shall show how the grid-tree representation helps one to discriminate between these two classes.

The general idea is that the grid-tree allows for a gradual data reduction of the image data. Reduction, by its nature eliminates differences between images—normal, and abnormal. The idea is to effect the reduction in such a way that normal differences would be eliminated more efficiently than the abnormal ones, and so one will be able to find a reduction state where the normal differences were sufficiently attenuated so that a BiPSA inference engine will be able to discriminate between these two classes of image differences.

For each application, according to its nature that reduction state will be different, and must be studied per case.

.Categorization of Image Differences

The first division is object and class. Obviously pictures of different airplanes will have marked differences, yet will retain enough similarities for a piece of software to discern that what is shown is a plane. The class of ‘airplanes’ can be narrowed down to the class of ‘airplanes of the same type’ where there are fewer differences. If we continue in that line of thought we shall say that pictures of the same particular airplane may have differences too.

Focusing on the differences of a particular airplane, we have causes of differences related to the positioning of the object vs. the camera, and positioning of any objects interfering with the image taking. And we also have differences regarding different cameras of different resolution and lens quality.

For different situations we are interested in different normal differences. If one takes pictures of the skies hunting for UFO (unidentified flying objects) vs. bona fide airplanes, then the object would be to distinguish between the class of man made airplanes, and some other flying objects built by mysterious extraterrestrials. A medical researcher egger to spot malignant tissue in some organ will need to neutralize the normal differences of that organ in different people. An air photography intelligence analyst will be focused on repeat pictures of the very same landscape, hoping to distinguish between normal changes, and menacing ones. If the application is concerned with spotting fraudulent changes within a document then it would need to distinguish between normal stains, and fraudulent modifications.

.Tracking Attenuation of Image Differences

Given two images, a, and b that are bit-wise non identical, one would apply the same tree-grid to both, and express them accordingly. At different generational depths the two images will have different fit indices. A general depth is the number of parent cells defined for the counted cells. At a given generational depth some cells of the two images will have the same value (three bits expression per cell, in the standard mode), and some will have different values. We define the ratio with the two figures as the fit-index for that generational depth:

$$FI = \frac{f}{m + f}$$

where FI is the fit index, f—the number of fit cells (same grid expression), and m the nonfit cells (different grid expressions). Clearly:
0≦FI≦1

Where FI=1 is a perfect fit.

Generally for high-level trees (greater reduction, smaller number of parental cells) the fit index will be higher.

One could enhance the fitness index exploring topological variations of the grid.

[image]

.Topological Variations of the Grid

The grid is overlaid with some incidental variations that may distort the inferential potential of the image. Such variations may be countered by exploring small enough variations in the cell configuration. In other words, given two grid-expressions of the same pictured image, one would opt to increase the fitness index, by nudging some cells into a different shape. By trying different shapes one would spot the variation that would net the highest fitness index, and use it as the basis for the inferential process.

Examples:

[image]

.The Grid Based Inferential Method

When an image is grid-expressed, it can be readily compared to other images. At a particular general depth, one may calculate the fitness index, and assume that the degree of discrepancy is based partly on what is referred to as ‘normal’ causes, and partly on ‘abnormal’ causes. The challenge here is to differentiate between these two.

This is done through training. One should assemble images where some abnormal phenomenon is absent, and assemble a similar group of images where the same abnormal phenomenon is present. For each image, at given generational depth each image is expressed through the same number of cells. One could then build a matrix that would list for image i, what is the value of cell j. Such table would be built for the two groups of images, and this would define a regular multi-variate case and handled accordingly. The same process can be repeated at different generational depth values, and one would choose the depth that is most suitable. The two principle considerations are: the credibility of the inferential result, and the computational burden. Deeper grid-trees involves many more cells, and require much more computation. If a similar result can be achieved with lesser trees, and especially if the situation is limiting the computational parameters then the higher level tree should be selected (fewer cells tree).

.The BiPSA Image Inferencital Method

Given n+m grid-expressed images with k cells each, where n is the number of images where some phenomenon of interest is non-existent, and m is the number of images where the same phenomenon is present, one would assume the standard three-bit expression for every cell, then one would express every image through k parameters: the value of its k cells.

According to the BiPSA methodology, the individual cells are the basic information units that express the image, so that in the first degree each of those cells will be regarded as a BiPSA dwarf.

So for a given cell x, it is found that a cell expression c (c={−N:+N}) appears at a ratio Ra in the group of “no phenomenon” (the zero group), and at a ratio Rb in the other group, where the phenomenon of interest does exist. Then in general if Ra>>Rb the BiPSA answer to the binary question: does the image represent the presence of the phenomenon in question, will be a strong negative, and if Rb>>Ra, the BiPSA opinion of that cell will a strong positive. In practice one would have to map the range of ratio values 0≦Ra, Rb≦1 to the BiPSA range: {−N:+N} (which can be different from the BiPSA appearing range for cell expression). In that way each cell will voice its binary opinion over the BiPSA question, and these opinions would be BiPSA integrated to form the more credible estimate that summarizes the individaul cell opinions.

At a second stage the cells will be paired either exhaustively or selectively to form a second set of BiPSA dwarfs, then a third (a combination of three cells or more), and the result will be super-integrated to the final opinion. One could repeat the same at different generational depth (especially higher level trees where the computation is easier), and eventually integrate the opinions that emerge from each depth level.

.Non-Human Sourcing Applications

A few are discussed below:
stock market forecast
computer security
police work
pattern recognition
   .Stock Market Forecast

In a stock market situation one tries to predict the future conduct of a given stock. One would categorize and BiPSA—integrate the various methods used in the market today (which are well documented). So, one would list:
technical forecasting (time series analysis)
analyst predictions
stock principals expectations
trends in industry similar stocks
trends in stocks that share a broad category
general economic forecasts

Each of these sources would be paired with several applicable inferential engines to produce a host of ‘dwarfs’ that will all answer each binary question in a cascade, and those answers will be BiPSA integrated, with the impact of each answer depending on the credibility that it gained in previous forecasting attempts.

Stocks fluctuate daily and hourly, this means that one could develop many test cases and learn from their experience how to best integrate the various BiPSA answers.

Computer Security

Hackers and computer fraudsters masquerade as bona fide users, hiding their malevolent intent. In principle the way to catch them is to differentiate them. Good hackers deny their observers a clear sign of their craft, and so the only way to do it is to read as many as possible attributes of the computer user, and properly integrate them into the decision: bona-fide/fraudster. BiPSA offers a perfect tool for that mission.

BiPSA is fast, incorporates thousands of parameters in real time computation, and so can render its verdict in a flash. Anyone trying to log on to a computer, submits information, and betrays even more. All that can be accumulated, and real-time BiPSA processed to judge status and grant or deny admission.

When a fraudster makes it in, he behaves in ways that distinguishes him from a bona fide user. These behavioral attributes can be BiPSA processed to spot the hack.

Police Work

The majority of the people are decent, straight and are of no interest to the police. A small minority of criminals though blends in, hiding among the decent majority.

Oftentimes flushing out these criminals is a case of assembling clues, and sparse evidence, and inferring upon guilt and capability. Since there are so many criminal cases, it would be easy to construct and evolve a BiPSA integration system that would read available data attributes regarding the population at large, and compute on their basis a suspicion profile to aid the police in their work.

This need, and the potential of such silent suspicion index, (or profile) has been greatly enhanced with the US Patriot Act that mandates the government to collect mundane but massive data on every American. We all show up on the government computers: our travel, our dining habits, our spending binge—all is part of our defining attributes, and each attribute will serve as a BiPSA dwarf to help compile a telling answer: are we obeying the law, or are we not.

Intelligence Analysis

National intelligence, or lesser case intelligence are marked with a glut of information that produced inconsistent conclusions. Traditionally intelligence gathering units resolve the inconsistencies in the midst and send up a sanitized version of their intelligence. The higher up unit resolves any conflicts arising from its information, and again, sends up a lopsided conclusion. This procedure creates loss of skepticism and doubts that rarely, if ever, bubble up to the top echelon. BiPSA can help by polling directly the lower echelons and low level sources with respect to any question of interest, and effecting all the conflict resolution at the very top, in the most mindful way.

Pattern Recognition

The classical cases of pattern recognition, be at hand writing, voice commands, facial attributes—are all a process of compiling a large number of telling parameters into a binary decision, and hence each and every one of these applications would qualify as a BiPSA case.

.Negating Data Contamination

Data may be contaminated by distortion, by noise, by poor resolution, and the result may resemble a random collection of bits rather than a meaningful content. The common way to negate such contamination is by restoration, by elimination of the distortion, the contamination, the poor resolution. BiPSA negates the contamination without such restoration process. Instead the BiPSA approach is to serve the eventual interest of the data user, namely, to answer that question whether the contaminated contents actually represent an object of interest. Hence a noisy speech might be challenged by the question: “Is this Jerry's voice?” (yes/no), or: “is the speaker saying ‘I love Lucy’?” (yes/no).

Similarly an MRI picture: “Does it indicate a budding tumor?” (yes/no). Another distinct application here is fraud detection. In this case the data contamination is motivated by criminal intent.

The BiPSA way here is to use the contaminated data to answer the binary question.

Typically in voice recognition, or image processing one has ample opportunity to train the system, and refine the integration network for improved credibility.

.Non-Uncertainty Applications

Categories:
solving mathematical problems
cryptography
gaming
   Solving Mathematical Problems

BiPSA may be of assistance in two categories:
1. Seeking proofs, and logical reasoning.
2. computational tasks.
   .Computational Tasks

Oftentimes computation is a process of picking up one element of given set. An alternative way to do so is by successive division of the set in a binary way, until the set includes one or few members which are the target of the computation.

This binary division can be done with BiPSA based on as many relevant parameters as possible.

Cryptography

The BiPSA network is essentially a reductionist process. This suggests that a BiPSA matrix multiplication is a one-way function, and hence fit for cryptographic one-way functions requirements.

Illustrations

Terrorism Crisis Management Illustration

Ideally, the crisis manager would wish to consult some wise and knowledgeable people, like his predecessor in this job, former members of the crisis management team, some experts in behavioral science, etc. Alas, there is no time for such consultation. The crisis manager today, interacts with one or two close assistants, and develops a response plan. BiPSA would give the crisis manager the distilled opinion of all those individuals that he would have liked to consult, but does not have time to do so. BiPSA forwards to these consultants (the BiPSA Board) a scenario for which the board votes up or down (binary vote), complemented with the confidence expressed by each board member in his own vote. These votes are integrated in accordance with the background of the board members, and in recognition of their relevant expertise. Thus a retired crisis manager would weigh more than a crisis team member, and an expert in behavioral science would count higher in a crisis involving hijacking, and count less in a crisis without a negotiation option.

[image]

Eventually, reality becomes an undisputable judge of these board votes, and the weights of the board members are adjusted accordingly.

BiPSA provides an excellent training environment for virtual crises, as well as a powerful tool for a real crisis. The BiPSA board may be dispersed geographically and without mutual communication. This may insure independent evaluation. Too often crisis situations suffer from “group think” where a dominant individual sways the votes. BiPSA counters that.

.The Managed Crisis

We describe below a specific crisis situation that may arise one day and challenge the crisis management team.

The Scene: A large city. The city builds a dedicated crisis management center which serves as a well protected, fortified communication hub, a reserve depot, as well as command and control center for the city. The idea being that the center would be protected against a whole host of possible attacks on the city, so that the crisis management team would remain operational to manage the crisis.

The Act Of Terrorism: A well-organized team of terrorists has secretly prevailed on a painting contractor to provide “bona fide” painters for his painting job in the secure command and control center. Passing as contractor personnel, the “painters” received entrance badges, (with pictures, signatures, etc.), and while inside they pulled out fire arms which were concealed in their painting gear, and quickly overcame the local guards, and soon after they have activated the “fortress mode” for the center, rendering themselves highly defensible. The terrorists have rounded the operators, the crew, and the management of the center, and have broadcast their demand to free imprisoned and notorious terrorists, and to arrange for a safe passage for themselves to another country.

The Initial Response: The police and the army quickly surrounded the invaded center, and the crisis management team conferred to take counter action. The time element loomed as critical. Electronic monitoring systems have detected that the terrorists use the powerful transmission at the center to air encrypted messages to an unknown recipient. It was conjectured that the terrorists communicate to their base the security secrets they glean from the center, and also perhaps some secrets that they extract through torture and threat from the captured personnel.

The elite rescue team found out that the underground tunnels were all blocked by the terrorists, and a smart counterattack is not feasible, at the moment. Some esoteric concepts are developed, but it would take at least 72 hours to come up with a practical option. One idea was to negotiate and basically accept the demands of the terrorists in order to save the lives of the 90 people trapped inside. Another idea was to launch a brute force attack that would likely cost the lives of most of the captured personnel, but would overwhelm the terrorists, and would deter any similar attack in the future.

The crisis management team prepared three response scenarios, and was ready to fire them off to the BiPSA board for evaluation.

The Optional Response Scenarios

The three response scenarios under consideration are:
1. Hold on for 72 hours to develop an optional smart assault plan.
2. Immediate, frontal attack with overwhelming force.
3. Negotiations aimed to save the 90 high profile hostages.
   The BiPSA Board

The three response scenarios under consideration should now be communicated to the BiPSA board for BiPSA voting. In reality there would be a dozen or two board members so as to thoroughly cover all the bases of knowledge regarding the proper response. Albeit, the graphical depiction of the BiPSA voting network would be too cumbersome to illustrate, and thus, for the purpose of this illustration we limit the number of BiPSA board members to three: Alice (A), Bob, (B), and Charlie, (C).

They are described as follows: Alice, Bob, and Charlie (A,B,C) form the BiPSA Board. Alice is a police profiler with high (H) skills in behavioral science, and Islamic culture. Bob is a former Crisis Center Commander with medium skills (M) in behavioral sciences, and high skills in Islamic culture, as well as in military rescue operations.

Charlie is a former member of the rescue team with medium skills in behavioral science, high skills in rescue operations, and no skills in Islamic culture.

From this description we can construct the following table:

TABLE 3.1

| | | Skills Set | | |
|---|---|---|---|---|
| BiPSA Board | Functional | Behavioral | | Rescue |
| Member | History | Science | Islamic Culture | Operations |
| Alice, (A) | 0 | H | H | 0 |
| Bob, (B) | H | M | H | H |
| Charlie, (C) | M | M | 0 | H |

The BiPSA Voting

Each BiPSA board member would answer three questions with respect to each crisis response scenario (a total of 9 multiple choice questions).

The three per-scenario questions are as follows:
1. With respect to the scenario in question, please mark one of the following statements:
   1.1 There is a better chance for the described scenario to happen than not to happen.
   1.2 There is a better chance for the described scenario not to happen than to happen.
2. With respect to the scenario in question, please mark one of the following statements:
   2.1 The described scenario is highly likely.
   2.2 The described scenario is highly unlikely.
   2.3 I am uncomfortable with either of the above statements.
3. With respect to the scenario in question, please mark one of the following statements:
   3.1 The described scenario is virtually certain.
   3.2 The described scenario is virtually impossible.
   3.3 The described scenario has a better chance to happen than not to happen.
   3.4 The described scenario has a better chance not to happen than to happen.
   3.5 I am uncomfortable with either one of the above statements.

One may note that the first (binary option) question does not allow for “neutral escape”, the respondents must choose a side. However, questions (2) and (3) relax that requirement, and allow a respondent to express his doubts by choosing the neutral escape in those two questions.

The answers to these three questions is converted to an integer as follows:
Combination: 1.1, 2.1, 3.1 evaluates to +4
Combination: 1.1, 2.1, 3.3 evaluates to +3
Combination: 1.1, 2.3, 3.3 evaluates to +2
Combination: 1.1, 2.3, 3.5 evaluates to +1
Combination: 1.2, 2.2, 3.2 evaluates to −4
Combination: 1.2, 2.2, 3.4 evaluates to −3
Combination: 1.2, 2.3, 3.4 evaluates to −2
Combination: 1.2, 2.3, 3.5 evaluates to −1

All other combinations are not logically consistent.

[image]

The results of the voting is summarized in the table below:

TABLE 4.1

| BiPSA | | Scenario 2: | Scenario 3: |
|---|---|---|---|
| Board | Scenario 1: Holding | Immediate Frontal | negotiate to |
| Member | on for 72 hours | Attack | save hostages. |
| Alice, (A) | +1 | −3 | +2 |
| Bob, (B) | −1 | +2 | −2 |
| Charlie, (C) | −3 | +1 | −3 |

.Integrating the Votes

The individual votes by the BiPSA board members can now be integrated, using the BiPSA method

The BiPSA integration is exercised through a network comprised of Unit BiPSA integrators (UBI).

We describe the UBI below, and then the integrating network.

.The Unit BiPSA Integrator

The Unit BiPSA Integrator, UBI, takes in any number of votes in the range {4:−4}, and computes an integrated result of the same format: {4:−4}.

[image]

The UBI integration algorithm is designed to be of extremely low arbitrariness. There are no arbitrary factors, no arbitrary coefficients, no arbitrary threshold.

.The BiPSA Network

The BiPSA network is comprised of UBI's threaded together.

We distinguish between the initial (a-priori) network configuration, and the evolving configuration.

The initial configuration is based on the attributes of the members of the BiPSA board, as defined by their resume. The evolving configuration is based on the evolving voting record of the board members.

The Initial BiPSA Configuration

The initial configuration is based on the attributes of the BiPSA board.

There are two attribute categories:
functional history
skills set

Functional history identifies the experience of board members in actual crisis management. Thus, a former crisis manager would weigh heavy. The skills set category identifies what the board members are knowledgeable about with respect to disciplines of interest. Thus, for a crisis involving a chemical factory, an experienced chemical engineer would count high.

The configuration, at its high level would identify the relative significance of the two categories. Suppose the decision is made that functional history counts more than skills-set, this determination would result in a configuration like this:

[image]

It reads: the integrated functional vote would count twice. First it would be cast against the integrated skills-set vote, and then it would be cast again, against the result of the first integration. This would give the functional vote a greater influence than the skills-set vote. What is left is to define the configuration that produces the integrated functional vote, and the integrated skills-set vote.

Integrating the Functional History Vote

The functional history vote would be integrated in accordance with the proximity of the voter to the role of crisis manager. Thus, a former crisis manager would be a high-impact vote,(H), a former member of the decision team, a medium-impact vote, (M), and a rescue team member would be a low-impact vote. A voter who has no history of being part of the crisis decision team, or crisis rescue team, would have a zero-impact vote on the integrated functional vote.

The respective configuration would be as follows:
Vf=[Va,Vb,Vc]*

Meaning the functional vote, Vf, would be the output of a unit BiPSA integrator, where the inputs are: Va, Vb, and Vc, and where:
Va=all the votes.
Vb=Va—[Low impact vote]
Vc=Vb—[Medium impact vote]

Or graphically:

[image]

The configuration gives the high-impact votes three opportunities to be counted (in the Va group, in the Vb group, and in the Vc group). The medium impact votes are counted twice (in the Va, and in the Vb group), and the low impact votes are counted once (in the Va group).

As the voters table show: Bob's vote is a high-impact vote, Charlie's vote is a medium impact vote, and Alice's vote is a zero-impact vote.

And thus the functional vote, Vf, would be:
Vf={{B,C},{B,C},{B}}**

Or graphically:

[image]

Integrating the Skills Set Vote

We identify three skill set categories:
rescue operation
behavioral science
Islamic culture

We envision that each skill category would have an integrated vote: Vr, Vb, and Vi respectively. And we decide on some priority order among these skill categories. Say:
[Vr]=[Vb]>Vi

Meaning: the integrated rescue vote, would be of equal ranking to the integrated vote of behavioral science, and both votes would have a priority over the Islamic culture vote.

This ranking order may be expressed in the following configuration:
Vs={{Vr,Vb,Vi},{Vr,Vb}}

Or graphically:

[image]

This configuration calls for Vr, and Vb to be counted twice, while Vi is counted only once.

Each skill set vote would be integrated from the individual votes using a rank order based on the level of competence of each voter with each particular skill set.

For any given skill set, there are voters of high-competence, (H), medium competence, (M), Low-competence, (L), and zero competence.

The zero competence votes would not be counted. The rest would be counted as follows:
Vk={VA, VB, VC}

Where:
VA=all the non-zero votes.
VB=VA votes minus the low-competence votes.
VC=VB votes minus the medium-competence votes.

And Vk is the integrated vote of that skill category.

Graphically:

[image]

Accordingly the various skill set configuration would be carried out as follows:

.Behavioral Vote

The BiPSA board attribute, as defined in the attribute table indicates that Alice has high-competence in behavioral science, Bob, and Charlie have medium-competence.

Accordingly:
Vb=[[A,B,C], [A, B, C], [A]}

Where A, B, and C are the votes of Alice, Bob, and Charlie respectively.

.Rescue Vote

The BiPSA board attribute, as defined in the attribute table indicates that Bob and Charlie claim high-competence in rescue operations, while Alice has zero competence.

Accordingly:
Vr=[[B,C], [B,C], [B, C]]=[B,C]

Where B, and C are the votes of Bob, and Charlie respectively.

.Islamic Culture Vote

The BiPSA board attribute, as defined in the attribute table, indicates that Alice and Bob have high-competence in Islamic culture, and Charlie has zero competence.

Accordingly:
Vi=[[A,B], [A, B], [A,B]}=[A,B]

Where A, B, are the votes of Alice, Bob respectively.

The Evolving BiPSA Configuration

The BiPSA evolution happens when a voted scenario is carried out, and then it either happens as planned, or it does not. Either way, the vote of each member of the BiPSA board is comparable to reality.

The more scenarios are actually tried out, the greater the feedback for the BiPSA board members. This feedback would distinguish between board members who tend to be right, and those who tend to have no apparent correlation between their vote and reality.

The BiPSA evolutionary algorithm would adjust the network to reflect this distinction among the BiPSA board members.

Such distinction can also come from virtual crises which are analyzed at leisure after the exercise, and it is determined which scenario is likely to have happened, and which is not. The important point is that the BiPSA network improves with use. It reconfigures itself to reflect the real experience of its past operation.

.The Overall BiPSA Network

The analysis above, once combined, results in the following network:

[image]

In summary, the BiPSA attributes are as follows:

Main Advantage: under pressure consulting with a large group of helpful individuals.

BiPSA does not replace any existing security feature, or any working decision-support device. It complements them all.

BiPSA spells consensus. By being consistent with the BiPSA recommendation, the crisis manager wins a broad and solid body of support. A great help against “Monday morning Quarterbacks”.

BiPSA is an excellent training tool. A BiPSA user would be stimulated to train himself and his team through a variety of imagined virtual crisis scenarios. The very handling of such scenarios would make it easier to face the real one, once it happens.

BiPSA is readily available, and inexpensive.

Illustration: Integrating Expert Decision

[image]

[image]

Illustration: Mapping Computed Cost to BiPSA Rating

Let the BiPSA scenario specify the cost of a given project to be between an L (low), and H (high) values. Let C represent the cost estimate according to some computing package. The BiPSA rating (−N:+N) will be determined as follows:
1. Compute the BiPSA rating interval, d=(H−L)/2N
2. Divide the cost line to BiPSA intervals as follows:
a. BiPSA=+N, for C falling in the range: (H−L)/2−d, (H−L)/2+d
b. BiPSA=+(N−1) for C falling in the ranges: (H−L)/2−d, (H−L)/2−2d: (H−L)/2+d, (H−L)/2+2d
c. BiPSA=+(N−k) for C falling in the ranges: (H−L)/2−kd, (H−L)/2−(k+1)d: (H−L)/2+kd, (H−L)/2+(k+1)d
   for k=1,2, , , , N−1
d. BiPSA=−k for C falling in the ranges: L−kd, L−(k+1)d: H+kd, H+(k+1)d for k=1,2, , , , N
e. for C<L−Nd BiPSA rating will be −N
f. for C>H+Nd BiPSA rating will be −N

[image]

This procedure defines the BiPSA interval as a function of the scenario cost interval. It allots a higher positive BiPSA rating for instances where the computing package is closer to the middle of the BiPSA scenario range, and, it allots a lower BiPSA rating for instances where the computing package estimated figure is further away from the BiPSA scenario range.

Illustration: Secret Voting Procedure

The following procedure will allow BiPSA respondents to communicate their vote with minimum information (not to betray style), and with complete security.

The (2+3+5) 10 BiPSA choices can be assigned values from the series 2ⁿ: 1,2,4,8, . . . 1024. The answer to the three questions will be added arithmetically. The resulting vote, V will be interpreted without ambiguity since the integer equation:
V=2^{a}+2^{b}+2^{c} (26)
has one and only one solution (a,b,c).

The r respondents will be assigned a secret number, Rᵢ for respondent, i, where the series R will abide by:
Rᵢ₊₁−Rᵢ>2¹⁰+2⁹+2⁸ (27)
for i=1,2,3, . . . r−1

The right side of this inequality represents the highest possible value for V. Accordingly, by transmitting Tᵢ=Rᵢ+Vᵢ, the i-th respondent will communicate to the BiPSA manager both his id, Rᵢ, and his vote: Vᵢ without ambiguity. An eavesdropper capturing Tᵢ will not be able to break out Rᵢ and Vᵢ, and so will remain in the dark with respect to who voted, and what that vote was.

Illustration: Genetic Algorithms to Enhance BiSA Integration

If the knowledge base consists of n data elements, there are 2n data sets that can each be regarded as a BiPSA dwarf. This number may be daunting, and so alternatively one would use n data elements and apply genetic algorithms to combine them to efficient new units, and thereby select the most useful combinations of data elements.

[image]

What is claimed is

1. a method to represent data via a collection of n entities each associated with a “vote” expressed as an integer between −N and +N where N is a natural number, and to reduce (integrate) these votes to a single vote also expressed in the same range, such that the reduction will be helpful for a variety of applications, included, but not limited to inferential challenges, learning, innovation, handling uncertainty, computational tasks, cryptographic primitives, and games, the method comprising
(1.1) a data processing mechanism conducive both to reduction and expansion of information
(1.2) providing a self-organizing, adaptive integration process to integrate the said votes into a reduced summary vote operating via,
(1.3.1) A Unit Integrator complying with the following terms:
(1.3.1.1). single output term.
(1.3.1.2) Permutation invariance.
(1.3.1.3) Symmetry
(1.3.1.4) Monotony
(1.3.1.5) Full-range terms for same sign instances.
(1.3.1.6) Full-range terms for mixed signs instances.
(1.3.1.7) N-invariance, and
(1.3.2) a network comprising threaded unit integrators
(1.4) mapping the integration process in (1) into a form reflective of matrix algebra providing commensurate mathematical computations,
(1.5) reflecting relative impact of n voters by designated weights in the form of natural numbers, such that the value of the weight will correspond to the number of times that vote is counted in a network comprised of Wmax unit integrators, where Wmax is the highest weight designation, and unit integrator i uses as input all the voters with weight designation i or above, feeding the resultant w voted into another unit integrator to produce the final weighted vote.

2. The method in (1) applied to handle uncertainty, exercise learning, and rendering unknown into known, the method comprising (2.1) dividing any uncertainty, or unknown information into a cascade of binary questions, each of which, in turn, is handled via (1) above.
(2.2) unifying all sources of wisdom and knowledge with regard to an issue in question, and integrating them fairly and usefully
(2.3) providing, or identifying a collection of voter entities (human, or data elements) issuing a binary vote over a binary question, and
(2.4) representing the binary vote with a confidence measure expressed via a range of ordinal numbers from −N (highest confidence negative answer) to +N (highest confidence positive answer), featuring 2N+1 options where N is an arbitrary natural number,
(2.5) integrating the votes via a network that adapts itself via feedback wherein voters exhibiting strong correlation (regular or reverse) with what eventually turns out to be the correct vote are respectively endowed with greater impact on the integrated result, and that impact is commensurate with the voter's expressed confidence such that correct high-confidence votes gain more impact on the integrated vote than the lower-confidence votes while incorrect high-confidence votes lose greater impact on the integrated vote than incorrect low-confidence votes, and where integration is otherwise enhanced via genetic algorithms designed to enhance the usefulness of the integrated vote.

3. The method in (1) applied to allowing a group voters associated with impact factors as in (1.5) to rank-order a target group, where the target group may be the same or different from the voters' group and where the ranking is accomplished by a series of binary questions comparing ranking favorability of two group members at a time, such that these binary questions are answered by the groups of voters according to the method in (1).

4. The method in (1) applied to allowing groups of individuals or organizations to serve their joint goal by providing operational and inferential flexibility between command hierarchy, and complete equality of members, the method comprising of
(4.1) allowing the members of the group to rank order the group members vs. every operational issue, or issue of decision, and
(4.2) using that ranking as impact designators within the integration process as in method (1),

5. The method in (1) applied to providing for a useful conclusion drawn from n sources of knowledge where k factors are identified to impact that conclusion, each in its own way, the method comprising,
(5.1) identifying for each source the degree of association with each conclusion factor, and using that association to govern the integration of the various sources' opinions, using the method in (1).

6. The method in (1) applied to providing for identifying image irregularities, distortions, and contamination by using the image data as voters over a cascade of binary questions as in (1) such that the answers would determine said irregularity, the method comprising
(6.1) a training process where images with and without the expected irregularities are processed by the method in (1), and the reality check effecting a re-configuration of the integration network as in (1), and
(6.2) a grid-tree, a hierarchy of grids that is superimposed on the image either as a set of Cartesian framework lines, or as polar elements anchored on a single anchor point on the image, or as a grid anchored on two or more points on the image, where each grid-cell is further grid-divided iteratively, and
(6.3) each grid-cell is identified by the ratio of pixels of two reference colors in the cell, mapping such ratio to a range of integers from “−N” to “+N”, such that the higher the integer the greater than one the ratio between the first and second reference colors, and
(6.4) using these integer expressed cell contents as reduced expression of the image, where each cell will be regarded as a voter, and its contents will determine its vote on any binary component of the irregularity question of interest, where such determination is based on the probability of each cell contents figure to be found in an image with irregularity as opposed to images without irregularities, and where
(6.5) the cells data is aggregated to cell groups either comprehensively where n cells define 2ⁿ data elements, or alternatively using a genetic algorithm to couple effective cells into new voters, and thus re-configuring the network.
